(19) United States
(12) Patent Application Publication
(10) Pub. No.: US 2005/0004837 A1
(43) Pub. Date: Jan. 6, 2005

(54) System and method for compounded marketing

(76) Inventors: Duane Sweeney, Bellingham, WA (US); Stephanie Hopkinson, Deming, WA (US); Harry Rosenberg, Ingomar, PA (US); Radoj Glisic, Baden, PA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/763,635

(22) Filed: Jan. 22, 2004

Related U.S. Application Data
(60) Provisional application No. 60/441,974, filed on Jan. 22, 2003.

(30) Foreign Application Priority Data
Jan. 22, 2004 (WO) PCT/US04/01975

(51) Int. Cl. G06F 17/60

(52) U.S. Cl. 705/14

(57) ABSTRACT

A system and method to facilitate computer-based commerce is presented. The system may including a module to facilitate communicating a vendor offering to a user if the offering is within a category designated by the user as being acceptable for receipt of such offering. The acceptable categories may be stored in user profiles, a user profile being updated when the user chooses to add or remove an interest category. When a vendor offering is received, the offering is categorized and stored in an offerings database. The vendor offering is then matched with a category in the user profile When the vendor offering is communicated to the user, the user's address or the user's identity is not revealed to the vendor. If a user chooses to propagate a vendor offering to another user, the user may be entitled to a reward. The reward may be designated to the user or to a third party. A spam control module may also be provided to identify spam complaints and to take actions in response to the spam complaints.

The present application claims the benefit for the filing date of U.S. provisional patent application Ser. No. 60/441,974, filed Jan. 22, 2003.

### FIELD OF THE INVENTION

This invention relates generally to the field of data communications, and more particularly, to a system and method for compounded marketing.

### BACKGROUND

It wasn't too long ago that advertising a product or service took only a loud voice and strong lungs. Attempts have been made by retailers to regain the intimacy and the relevant dialogue of the smaller community. One example is customer lists developed by retailers using purchase histories. These are routinely used to target consumers according to purchase history. While this has met with some success, it still fails to meet the objective of matching a product or service with a consumer's current need—the retailer is sending out advertisements based on past purchases to a customer who may no longer have a need for that particular type of product.

The Internet is changing some of these paradigms. Internet users actively search for what they want or need. They are not so eager to have a “commercial” take over their screens for even 30 seconds. In like manner, consumers find spam (unwanted e-mail) that fills their e-mail in-boxes annoying. There is a need to provide means to identify probable customers (who can filter what they see) for a given item of merchandise and to change the relationship between consumers and producers in that advertising and marketing now occupy the same channel.

### SUMMARY OF THE INVENTION

According to one aspect of the present invention, there is a system and method provided to facilitate computer-based commerce, the system including an offering dispatch module to facilitate communicating a vendor offering to a user if the offering is within a category designated as by the user as being acceptable for receipt of such offering and a rewards module to reward the user if the user satisfies a reward criteria, the reward criteria including the user propagating the provider offering to a second user. The system may also include a user profile monitor to maintain a user profile, the user profile including one or more user selections from a plurality of categories, a vendor communication module to detect receipt of the vendor offering, and an offerings monitor in communication with the vendor communication module to identify the offering as associated with an offering category and to store the offering in an offerings database. When the vendor offering is communicated to the user, the user's address or the user's identity is not revealed to the vendor.

According to another aspect of the present invention, the system may include a user communication module in communication with the user profile monitor to receive a selection of at least one category from the user and to store the selection in the user profile. The user profile may be independent from the user's communication service provider.

The system may also include an intelligent agent to identify a related category associated with the selection of the at least one category and to publish a product associated with the related category to the user. The user may also be invited to select the related category to be included in the user profile, and a statistics generator to automatically generate a value associated with a number of user profiles identified as including the offering category.

According to yet another aspect of the present invention, the offering dispatch module may be configures to detect a change to the user profile, identify the change as an additional category in the user profile, identify a new interest offering in the offerings database, the new interest offering associated with the additional category in the user profile, and facilitate communicating the new interest offering to the user.

According to a further aspect of the present invention, the rewards module is to reward the user responsive to a sale to the second user resulting from the user propagating the vendor offering to the second user, or a click-through by the second user resulting from the user propagating the vendor offering to the second user. The reward may include one or more items selected from a group including a credit value, one or more points, and a monetary value. The reward may be designated to the user or a third party.

According to a further aspect of the present invention, the system may include a spam control module in communication with the offerings monitor to receive a spam complaint, to identify a vendor associated with the spam complaint, and to take an action in response to the spam complaint.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system having a client-server architecture, according to one exemplary embodiment of the present invention.

FIG. 2 is a block diagram illustrating a compound e-mail system to facilitate computer-based commerce utilizing compounded e-mail, according to one exemplary embodiment of the present invention.

FIG. 3 is a flow chart illustrating a method to facilitate computer-based commerce utilizing compounded e-mail, according to one exemplary embodiment of the present invention.

FIG. 4 is a flow chart illustrating a method to facilitate computer-based commerce utilizing compounded e-mail, characterized by two distinct entry portals, according to one exemplary embodiment of the present invention.

FIG. 5 is a block diagram illustrating components to facilitate interaction between different participants in the compounded e-mail system, according to one exemplary embodiment of the present invention.

### BRIEF DESCRIPTION

According to one aspect of the present invention, there is provided a system that is a new arrangement and integration of elements of the Internet and of e-commerce to create a new vehicle with new and valuable characteristics, and which may conveniently be termed “Affiliated E-mail”. The system may operate through a central hub, which processes e-mail messages and performs other functions. The elements it recombines may include e-mail, affiliate tracking software, customer relationship management software, e-commerce, standard websites, one-to-one marketing, and other components.

In an exemplary embodiment the present invention may encompass: (i) peer-to-peer marketing, where individuals send commercial and other messages to their personal contacts; (ii) payment for results, where referral fees for sales or other measurable actions are tracked through affiliate software and paid to participants, which may be a multi-tier system; (iii) database tracking of personal preferences as provided by participants, where personal and interest profiles facilitate appropriate contacts and protect against unwanted contacts.

Direct comparison of codes on vendor offers and personal preference codes as a determiner of further action may also be implemented as part of the system. For example: The topic ‘Cats’ would have a code, ‘Show Cats’ a more restricted code, and ‘Short-haired Show Cats’ a still more restricted code, etc. (By way of example, the cataloging system used by the Library of Congress or other cataloging or ontological systems could be utilized or adapted for use in various embodiments of the present methods and systems.) If a user's personal profile is set to block all offerings (e.g., advertisements, commercial e-mail, etc.) except those about ‘Short-haired Show Cats’, all offerings not related to ‘Short-haired Show Cats’ would be prevented from reaching that user by the central hub within the present system, which would check the user's confidential personal profile before sending any coded message. All commercial messages are appropriately coded in accordance with the methods of the present invention. Flexible allocation of referral fees to self or to third parties is also facilitated within embodiments of the present invention. A database of third parties for referral fee allocation may be provided, so that anyone can choose to redirect their referral fees to anyone in the database. In one exemplary embodiment, participants can add, or suggest the addition of, an organization or person to the database.

The system may include an e-mail service based on a central hub, accessible via the Internet or other computer networks or networks of networks.

A database of current offerings from providers may also be provided. In one exemplary embodiment, a provider may be a vendor of goods or services. The offerings from providers, however, are not limited to financial transactions for goods or services. The current offerings may be in the form of modules that may be added to personal e-mails. One or more modules may be selected from a collection of such modules. A method may be provided to track results so that the sender is credited appropriately.

In one exemplary embodiment, every person who signs up as an affiliate and sends the affiliated e-mail to someone who buys the product/service, generates money or credits, which can be assigned to them or to anyone they choose. Accordingly, one aspect of the present invention proposes a viral, self-propagating way to reach an entire community of interest, and only that community of interest, through person-to-person connections and personal recommendations. Credits/rewards may be provided even if subsequent recipients of the e-mail do not purchase the associated product/service.

In an exemplary embodiment this system may be a hybrid of word of mouth recommendations; personal connections augmented with database completeness, accuracy, speed and ease of use; affiliate programs, providing personal earnings or the ability to donate to others; e-mail; modular assembly of messages and web pages.

In an exemplary embodiment of the present invention, the propagation of a message is effectuated while maintaining the fidelity of the message through any number of transmissions. A finder's fee may be payable to the person who transmits the message to another person who makes a purchase. The system may provide a positive cash flow for the seller, as credit card sales may fund the seller before they have to pay commissions to affiliates or to the compound marketing system. Other features may include: built-in protection with spamming controls, a self-organizing structure that optimizes for efficient, thorough transmission to the whole online population, quality assurance of functionality at every step with the community of members determining the quality of content, ancillary organizational features that are correlate of the basic structure, which have their own value and consequences (community web sites, for example); hardware and software to effect the above; networks to connect the various functional components; and means for triggering billing and shipping procedures both local and remote.

Definitions

Recipient: anyone who receives a communication (e.g., e-mail) from the system.

Participant: anyone who may respond to or forward compound e-mail, but is not a member or an affiliate. Participants do not earn commissions.

Member: anyone who has created an interest profile of themselves in this system. Such a profile identifies them to the system, allows them to screen e-mails coming from the system in (potentially) both positive and negative terms, and may give them access to other features of the system such as use of community pages, e-mail service, and use of the database address book feature.

Affiliate: a person or other entity with a business relationship in which they may earn commissions for referring individuals who make a purchase or being the proximate cause of other desired actions.

Publisher: an entity (e.g., person or company) provided by the system with the ability to combine one or more pre-existing modules and/or other content into a single new module, from which they will earn commissions from every desired result generated, no matter how many generations of transmission occur or which module contained within the publication is responded to.

User: Anyone interacting with the system.

Affiliate marketing: an approach to marketing that uses affiliates to find and refer appropriate prospects.

Affiliated e-mail: an alternative term for compound e-mail.

Commission: any benefit accruing to a payee for producing a desired result for the provider. It may be cash, credit, discount, donation to a third party, or any other good or service or consideration of value, including simple recognition.

Compound affiliated e-mail marketing: a general term for what this invention accomplishes.

Community pages: pages or sites within a system, which support interactions among members sharing one or more interests.

Compound e-mail: a combination of one or more modules and a message from, or at least the identification of, an affiliate, such that the system recognizes the affiliate and can track transmissions of the compound e-mail, along with responses to it (if any). The message may be whatever the affiliate sending it chooses. It may also be automatically generated in the case of automated forwarding, or institutional in the sense of being from the system itself or from the provider in the case of sending to seed lists.

Hub: a central management point for the compound e-mail system. It may be physically unified or dispersed, but is a useful mental construct. All compound e-mails may be sent directly from the hub, allowing them to be updated or blocked. All interest profiles are stored in and checked by the hub before sending compound e-mails. Financial tracking, membership and affiliate status, and other functions best performed in a centralized manner may be also concentrated in the hub.

Module: a piece of content that is packaged such that it can pass through the system and through other e-mail systems without being altered. Additionally, it is coded as to the type of content such that the code can be detected without anyone being exposed to the content, and there are also means to track its passage through the system. It may contain any type of content transmissible through e-mail, including commercial offerings with provision for placing orders.

Module family: a multiplicity of modules containing material relating to the same specific topic or offering, differing in their presentation, size, or other variables.

Payee: any individual or organization to who commissions are directed. This may be an affiliate, a third party designated by the affiliate, or a third party designated in the module.

Persistent affiliation: an affiliate arrangement for a particular module may include a feature of persistent affiliation. This means that if a recipient responds to a compound e-mail sent by an affiliate, the commission relationship with that recipient established at that time will persist through time, under the conditions of the affiliate arrangement for that module. The length of time may be of any duration, or it may apply to certain sorts of transactions but not others, or all transactions, etc.

Provider: a creator of any offering or content encapsulated in a module.

Publication: the “module of modules” created by a publisher. It is a second layer of modularization, containing one or more other modules, along with optional other content. It is tracked as a single module, but commissions may be assigned to the publisher as well as to the affiliate who most immediately forwarded the publication that was responded to.

Referral credit: commission “banked” or reflected as a credit in the system.

Referral fees: commissions in the form of money.

Seed lists: lists of people who have selected the option to be the first recipients for compound e-mails related to specific topics. These can be used to begin the communication cycle with a new compound e-mail. Providers may have their own seed lists from in-house e-mail subscriptions, or they can be generated within the compound e-mail system and made available for the use of providers releasing compound e-mails into the system.

Support wave: a cooperative effort by multiple individuals to direct their commissions to a particular payee.

Offering: anything that is offered.

Community of Interest: an Internet space where people of shared interest may gather.

### DETAILED DESCRIPTION

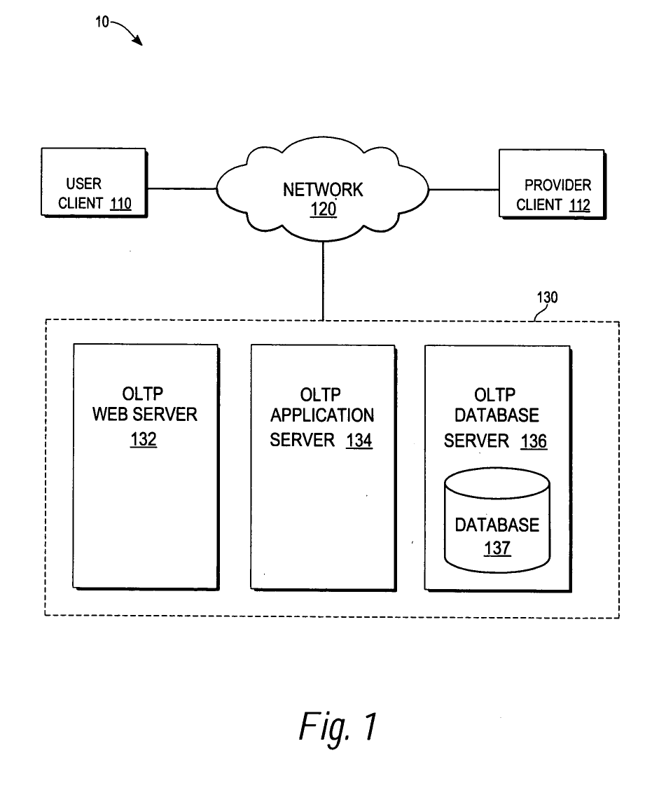

FIG. 1 illustrates a simplified view of the compound marketing system 10. The compound marketing system 10 includes a user client 110, a provider client 112, a network 120, and an compound marketing Web site host 130, which further includes a compound marketing Web server 132, a compound marketing application server 134, and a compound marketing database server 136. Further, the compound marketing database server 136 includes one or more databases 137.

The client user 110 is a computer system that enables a user (e.g., a potential recipient of a provider offering) to interact with the compound marketing system 10. The provider client 112 is a computer system that enables a user (e.g., a provider) who wants to view feedback to interact with the compound marketing system 10. The network 120 is a communications network, such as a LAN, WAN, intranet or the Internet. The compound marketing Web site host 130 is a system for hosting a compound marketing Web site. The compound marketing Web server 132 is a computer system that provides World Wide Web services, for example, to deliver Web pages using a markup language. The compound marketing application server 134 is a computer system that provides support for whatever functions are required by compound marketing Web site host 130, such as receiving and processing transaction requests received by the compound marketing Web site host 130. The compound marketing database server 136 is a computer system that stores and maintains tables or other data structures within the database 137 according to the specific architectural needs of the methods of the present invention, as described below. The compound marketing Web site host 130 includes one or more servers, which may be physically co-located or distributed in a distributed computing architecture.

In operation, a user operates Web browser software, such as Internet Explorer or Netscape Navigator, on user client 110 to navigate from user client 110 via network 120 to compound marketing Web site host 130. The compound marketing application server 134 receives a request to update the user's profile (e.g., to add or delete a category associated with an area of interest) from user client 110, processes the requests by storing the category the user profile in the database 137 within compound marketing database server 136, and transmits a response back to the user client 110 via network 120.

Likewise, a provider who wishes to submit a provider offering (e.g., an advertisement) into the compound marketing system 10, operates Web browser software, such as Internet Explorer or Netscape Navigator, on the provider client 112 to navigate from the provider client 112 via network 120 to compound marketing Web site host 130. The compound marketing application server 134 receives a request to submit an offering from the provider client 112, processes the requests by categorizing the offering and storing the provider offering in the database 137 within the compound marketing database server 136, and transmits the offering to the user operating the user client 110 if the provider offering is within a category designated by the user as being acceptable for receipt of such offering via network 120. In one exemplary embodiment, the offering is transmitted to a predetermined number of the eligible users only. The transmission may also be delayed according to a predetermined criteria. For example, a user may designate that he/she wishes to limit the total number of offerings received or to limit the number of offerings received per time (e.g., a week or month, etc.), thus allowing a user to protect herself from preventing the user from getting a lot of emails at once.

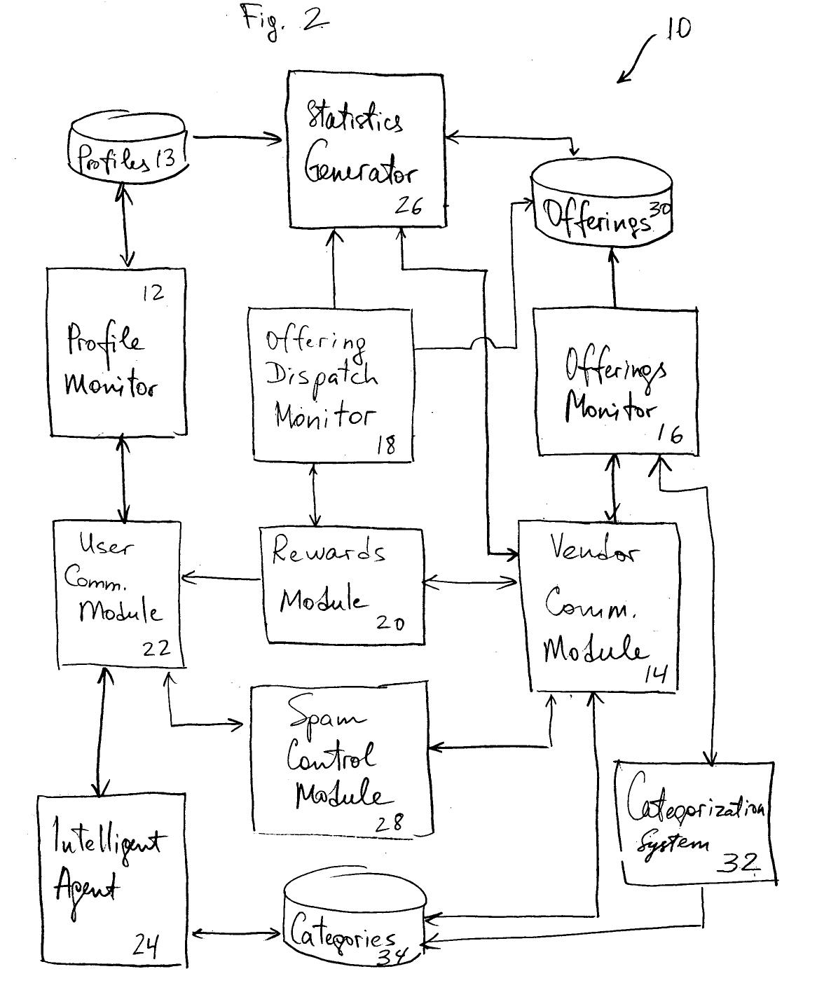

In one exemplary embodiment, the database 137 is a plurality of databases, such as a profiles database, an offerings database, and a categories database. FIG. 2 is a block diagram illustrating a compound e-mail system 10 to facilitate computer-based commerce utilizing compounded e-mail, according to one exemplary embodiment of the present invention. In this embodiment, the compound e-mail system 10 may include a user profile monitor 12 to maintain a user profile in a profiles database 13, a provider communication module 14 to detect receipt of an offering (e.g., an advertisement) from a provider, an offerings monitor 16 to keep track of the offerings available for distribution to users, an offering dispatch monitor 18 to facilitate communicating a desirable offering to the user and to prevent communicating an undesirable offering to the user, and a rewards module 20 to facilitate rewarding the users who participate in dissemination of the offerings. The offering dispatch monitor 18 may be also utilized to prevent communicating desirable offers that are greater in number or frequency than indicated by the user.

The compound e-mail system 10 may also include a user communication module 22 to allow a user to actively invite offerings related to a particular area of interest (e.g., a category), an intelligent agent 24 to identify one or more related areas or items of interest, and a categorization system 32 to categorize the offerings as the offerings are received from providers via provider communication module 14. The categorization system 32 is configured to operate in communication with a categories database 34 and the offerings monitor 16.

The rewards module 20, being in communication with and receiving information from the offering dispatch module 18, may operate to create incentives for the users to help propagate the offerings. A statistics generator 26 may be configured to collect information related to user profiles from the profiles database 13 information related to the offerings from the offerings database 30. The statistics generator 26 may utilize such information to generate data related to the degree of interest in different categories (e.g., how many users are interested in a particular category). A spam control module 28, in communication with the user communication module 22 and the provider communication module 14, may also be incorporated in the compound e-mail system 10 to deter senders of unauthorized offerings. In

Although the profiles database 13, the offerings database 30, and the categories database 34 appear as separate databases, the compound e-mail system 10 may be configured such that these databases are part of the database 137.

Product Entry

In one exemplary embodiment of the present invention, once an offering is deemed acceptable by the operator of the present system and an agreement is made between a provider and the operator of the present system, the provider communication module 14 may send the offering to the compound e-mail system 10. The offerings monitor 16 may store the offering in the offerings database 30 utilizing the provider communication module 14. The operations to enter the product into the system 10 may include categorizing the product; listing the product in appropriate places (e.g., a searchable database and “What's New” listings), so that the public and registered users (the users with profiles) can become aware of the product; creating a feedback mechanism (e.g., a web page) if desired; obtaining and displaying the feedback that accrues;, creating a sales page and an order fulfillment process in the agreement; creating modules that may be used in compound e-mails; releasing an initial compound e-mail to a seed list if appropriate; sending review copies to individuals if appropriate; creating alternative test versions of sales page and modules; and tracking responses and identifying a superior version as in the direct mail industry.

Categorization

A categorization system 32 (e.g., a cataloging system utilized by the Library of Congress or an Internet search engine, such as Yahoo or Google) may be used to categorize all offerings to a fine degree of discrimination, providing for selection by various criteria. Without limiting selection to these examples, criteria may include a type of offering (e.g., goods, service, wanted, etc.), a type of product or offering (a tool, an item of clothing, a vehicle, etc.), a price point including free, profit or nonprofit organization or payee(s), geographic proximity, brand name, or a unique identifier. This function may be performed by users, with or without wizard assistance, based on information and product supplied by a provider.

The categories may be stored in the categories database 34. The categorization system 32 may be a hierarchical system that allows increasing inclusiveness at higher category levels, or increasing discrimination at lower/finer category levels. It may be extensible in a logical and consistent way as products evolve and change. The user communication module 22 may be used to allow the user to select the categories representing the user's areas of interest and the user's consent to receive offerings that belong to the selected categories. The user profile monitor 12 may be utilized for database tracking of personal preferences as provided by participants, where personal and interest profiles facilitate appropriate contacts and protect against unwanted contacts. The user profile may be stored in the profiles database.

Navigation

The compound e-mail system 10 may include a navigational system (not shown) that allows users to browse through a hierarchy of categories to find just what they want. Without limiting it to this approach, the navigational system may operate in a fashion similar to the way a naturalist's key to identifying plants or other organisms works, by making successive choices or discriminations until the final identification is made. A unique code or other system may be used to identify each branching point of a decision tree. A user can indicate each such point as being of negative or positive interest to him/her and block or invite information from further down that branch, respectively.

Interest Profiles

The user communication module 22 may allow a user to access the compound e-mail system 10. The user may utilize categories and navigation to establish an interest profile (e.g., in a form of a screen) that may filter any e-mails originating from the compound e-mail system 10. The profile monitor 12 may be utilized to gather the interest profile data and store it in the profiles database 13. A profile may be established by any user, using any e-mail address, not only addresses within the compound e-mail system. The interest profiles are not dependent on having an e-mail account with the compound e-mail system. An interest profile may facilitate blocking compound e-mails of predetermined characteristics. This may be termed as a negative part of an interest profile.

A positive part of an interest profile is that a user can highlight in various ways the areas of specific interest, which may be accomplished by a variety of means. For example, a user may put him- or herself on a seed list for a topic, or choose to receive a compound e-mail from a particular sender whose selection of offerings and/or accompanying personal writing or other inclusions are of interest to the user. An interest profile may also indicate that the user is eligible for earning income from any commissions that might result from offering propagations, or an indication that the user is a subscriber to a publication produced by a publisher who addresses the user's interests.

Maintaining Interest Profiles

In one exemplary embodiment, the user profile is maintained by his/her Internet service provider (ISP) in the profiles database 13, and never leaves that venue. The user can select and deselect categories at any time, providing complete control over what he/she receives. In addition, the user can set a limit on the total number of e-mails he/she receives on the associated topic, or daily/weekly/etc. limits until the user cancels the topic.

In a further exemplary embodiment of the present invention, there is a centralized system to facilitate and maintain multiple profiles of the same person at multiple ISPs, within a peer-to-peer arrangement, or at a local ISP providing e-mail service.

The profiles may be generated at a managing organization (MO) (e.g., the compound e-mail system 10) and then communicated to a central location. Such central location may be independent of the ISP. For example, the profiles may be generated through the activity of an MO, which may be any organization permitted to solicit or publicize the system, and which may then earn a percentage of all monies paid for their use from that time forward. The profiles may be created and stored at a central location. Each profile may be marked with the originating MO's code, all profiles may be accessible to all MOs. An ISP is not an MO merely by virtue of being an ISP, but an ISP may elect to function as an MO. In one exemplary embodiment, one MO may become the custodian of all the profiles.

Access to the profiles could be free for the MO responsible for getting the first response, and at a cost for others, at least part of which is profit to the originating MO. This mechanism provides an incentive for MO to gather initial profiles, which will encourage those who are licensees to spread the system as fast and as far as they can. Profiles may become long-term sources of income in this way.

In one exemplary embodiment of the present invention, the statistics generator 26 may facilitate regular (e.g., daily) compilations of how many user profiles in the profiles database 13 have a specific category selected. This may be accomplished by a simple run of a counting program if the profiles are stored in a centralized manner, or by automatically collecting information from various ISPs and then formatting the data into an appropriate format, if the profiles are stored at the user's ISP

One advantage of centralized storage is that the participation of local ISPs is not required, and addresses problems that typically occur when a subscriber to an ISP discontinues a relationship with the company. The centralized storage avoids having to have the relevant profile moved, canceled and recreated, or having a copy kept in the user's e-mail program so it can be uploaded. The central warehouse proposed above seeks to addresses these issues. Consider further that, in this way, MOs can continue to generate revenue even from subscribers who leave, and if they fail to participate they are essentially giving income to some other MO.

A central facility may also manage the selling process to individuals. Specifically, a central facility may update the profiles, collect and disburse funds from sales, communicate with whichever entity needs to know to fulfill the order, and so on. Information on recent sales would make certain profiles even more valuable, increasing their income production, as recent purchase of a related item is one of the desirable characteristics of a mailing list.

The collection of user profiles (e.g., a profiles database 13) may be centrally maintained while providing distributed functionality.

Managing Organizations (MOs)

In one embodiment of the present invention, any organization with a way to reach an audience could collect profiles and profit from their rental or direct use. Magazine publishing companies are one example of such an organization. If a central facility handles sales and other distributions of, for example, free bonuses, information products, etc., the magazine company could make an attractive offer to its readers, such as a CD or free report, or discount coupon book from their advertisers, so readers may have an incentive to create profiles in order to receive the attractive offering. Radio and television stations, cable networks, and so on could all do likewise.

Example of Profile Utilization

This form of “capillary” advertising may be utilized for electronically accessed products such as software, e-books, music, movies, instructional courses, etc. Such delivery would incur little cost except bandwidth associated with delivery, and payment is usually received before delivery, so limiting the number of sales is unnecessary. The publishers could reach their market nearly instantaneously and permanently. For instance, a promotion for a book on childbirth could go out on this system and immediately reach everyone with pregnancy or childbirth related options selected in his or her profile. Then it could be forwarded to everyone each of these users know who is expecting, and this process could be repeated for many generations as new users open up their profiles and people who know them and the book send the ad to them.

A publisher could have an ongoing arrangement with an MO or the central facility to send an ad to everyone who opens up certain categories in their profiles. This could easily be the whole marketing program for a publication, set up once and active for as long as the publisher desires.

As this could be a common tactic, and as people might limit the number of ads to which they are open, and as being first is often desirable, the publisher might have to bid for top spots in this “instant delivery” system. This may encourage providers bidding against each other for a limited number of openings.

In one exemplary embodiment, the compound e-mail system 10 may utilize features that allow a provider to bid for a top spot. It may also factor in the user interest, as shown by response from users of the compound marketing system to the ads of various vendors, putting more interesting ads near the top. The compound e-mail system 10 may utilize a page of highly popular products, or products calculated to be of interest to the viewer, shown whenever a user forwards an ad. The intelligent agent 24 may facilitate gathering and compiling information to determine the consumer interest in a particular product at a particular location.

In some cases, the top spots could be rotated or spread out to allow more products a chance. For instance, the first X,000 exposures could be at one rate, with an increasingly steep surcharge for each additional X,000. This lets interested providers pay the premium if they so desire, while keeping the system open to other providers not interested in doing so.

In one exemplary embodiment, there may be a database of products being offered through the system. The database may be associated with an MO. This way individuals could find the products they want to use or forward, can divert some of the funds from purchase to their favorite cause (including themselves), could develop themselves as expert reviewers in specific product areas, with mailing lists of subscribers (supported by the MO, as this would increase sales credited to them).

Communicating Changes to Interest Profiles

When a user creates or updates an interest profile the user can choose to communicate those changes to various people in a variety of ways. The changes to a profile may be made visible to all (e.g., in a public profile, or a public section of an interest profile) or only to predetermined individuals. The user may selectively communicate the changes to his/her profile to any potential sender who already has the user's data in the sender's personal contact database or only to those who have the user's data in sender's database and coded with interests, positive or negative, in such a way that the changes are relevant to that coding. The user may choose to automatically update a sender's database, or effectuate an alert or a message about the changes.

Another way to affect the interest profiles is from a sender (e.g., provider) side. A sender may request that a potential recipient look at all or part of the interest profile they have constructed and correct it, in the interests of aiding the sender in sending only offerings that are of potential interest. There may be a private part of this profile that the sender does not show to the recipient, as it may contain notes or other information about the recipient that the sender does not wish to reveal to the recipient.

Various refinements and extensions of this approach are possible, and would be apparent to a person skilled in the art after reviewing this specification.

Access

In one exemplary embodiment, the offering dispatch module 18 performs a comparison of codes (e.g., associated with categories and subcategories) on provider offerings and personal preference codes in the user's profile, to determine further action. For example, if a ‘Cats’ category has a code, a ‘Show Cats’ category would have a more restricted code, and a ‘Short-haired Show Cats’ would have a still more restricted code. If a user set her personal profile in the profiles database to block all offerings except those about ‘Short-haired Show Cats’, the offering dispatch module would block all other offerings, because the offering dispatch module compares the offerings category to the user's profile data prior to allowing the offering to be sent to the user.

Thus, in one exemplary embodiment, the offering dispatch module combined with the profile monitor may allow a user of the compound e-mail system 10 to block all e-mail from specific senders; block compound e-mail but not personal e-mail, block personal e-mail but not compound e-mail; block all but specific senders; or block all e-mails containing offerings (e.g., e-mails coded in ways that identify them as offerings) from any selected branch or branches of the hierarchy of offerings and products; block all compound e-mails from one or more branches of interest, yet allow specific exceptions to reach her; block all e-mails except the first containing any of a module family (e.g., any group of related modules, which contain one or more common code elements identifying them as related); block all e-mails except the first x, where x is any number chosen by the recipient, containing related modules, or members of a module family; and/or block all compound e-mails for a given period of time (e.g., while on vacation). Thus, the user is able to control what she receives, from whom, how many times she receives it, when she receives it, and so on for other aspects of e-mail reception that may be evident to a person skilled in the art.

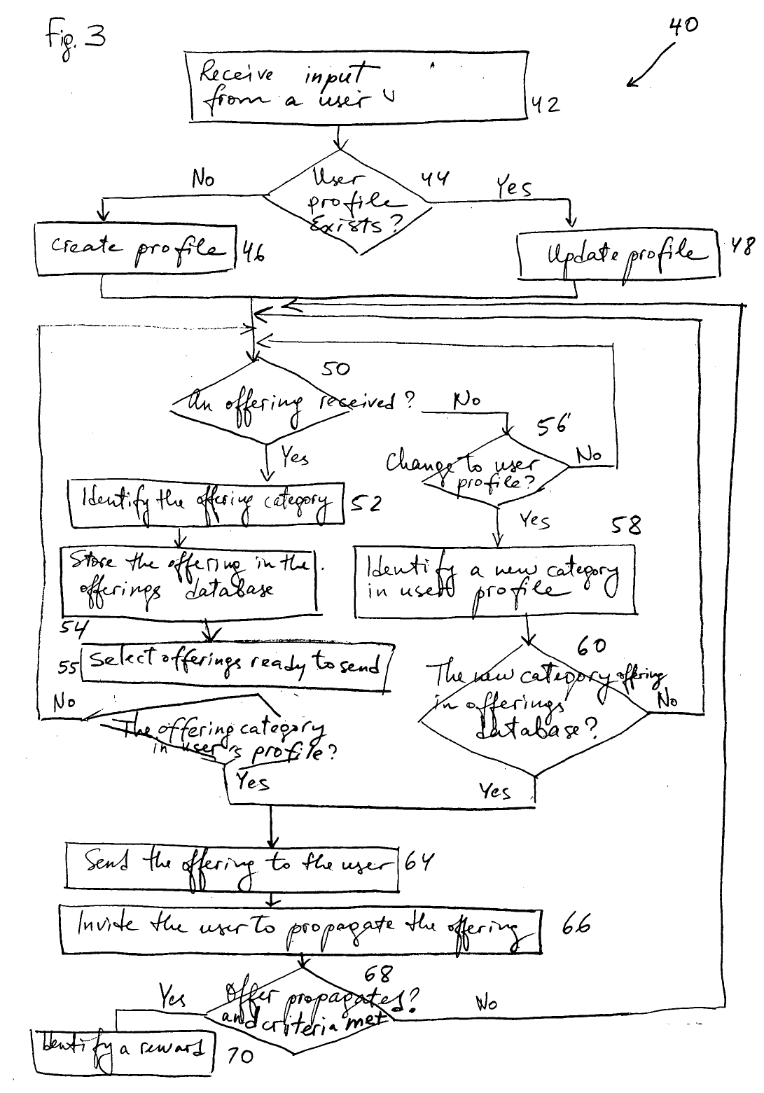

FIG. 3 is a flow chart illustrating a method 40 to facilitate computer-based commerce utilizing compounded e-mail, according to one exemplary embodiment of the present invention. The compound e-mail system 10 receives input (e.g., a category selection) from a user at operation 42. A new user may contact the system in other ways as well. For example, by responding to a sales offer, by responding to a solicitation to join, by choosing to block any or all categories, by making a spam complaint, by requesting a free product as an incentive, by pure curiosity, etc. If the user profile exists at operation 44, the user profile is updated with the selected category at operation 48; otherwise the user profile is created and stored in the profiles database at operation 46. When an offering is received from a provider at operation 50, the offering is assigned a category at operation 52 and stored in the offerings database at operation 54. At operation 55 the offerings that are ready to be sent are selected. If it is determined at operation 62 that the offering category appears in the user profile, and if all other delivery criteria are met, the offering is sent to the user at operation 64.

The profile monitor 12 monitors the profiles database to determine if there was a change to the user profile (e.g., a new category was added), the offering dispatch monitor identifies a new category in the user profile at operation 58. If) it is determined at operation 60 that the offerings database 30 includes an offering associated with the new category and all other delivery criteria are me), such offering is sent to the user at operation 68.

When the offering is sent to the user at operation 68, the user is invited to send the offering to other people at operation 66, if the user believes that the offering is of interest to them. If the user forwards the offering at operation 68, the user may be entitled to a reward at operation 70 if, for example, the forwarded offering resulted in a sale.

In one embodiment, users have the ability to actually write something unique and possibly personal in the forwarded message. Alternatively, passing on a commercial e-mail to other users might consist of simply adding one's identifying information (i.e., name, code, etc.) to a standard e-mail, perhaps with only one mouse click command.

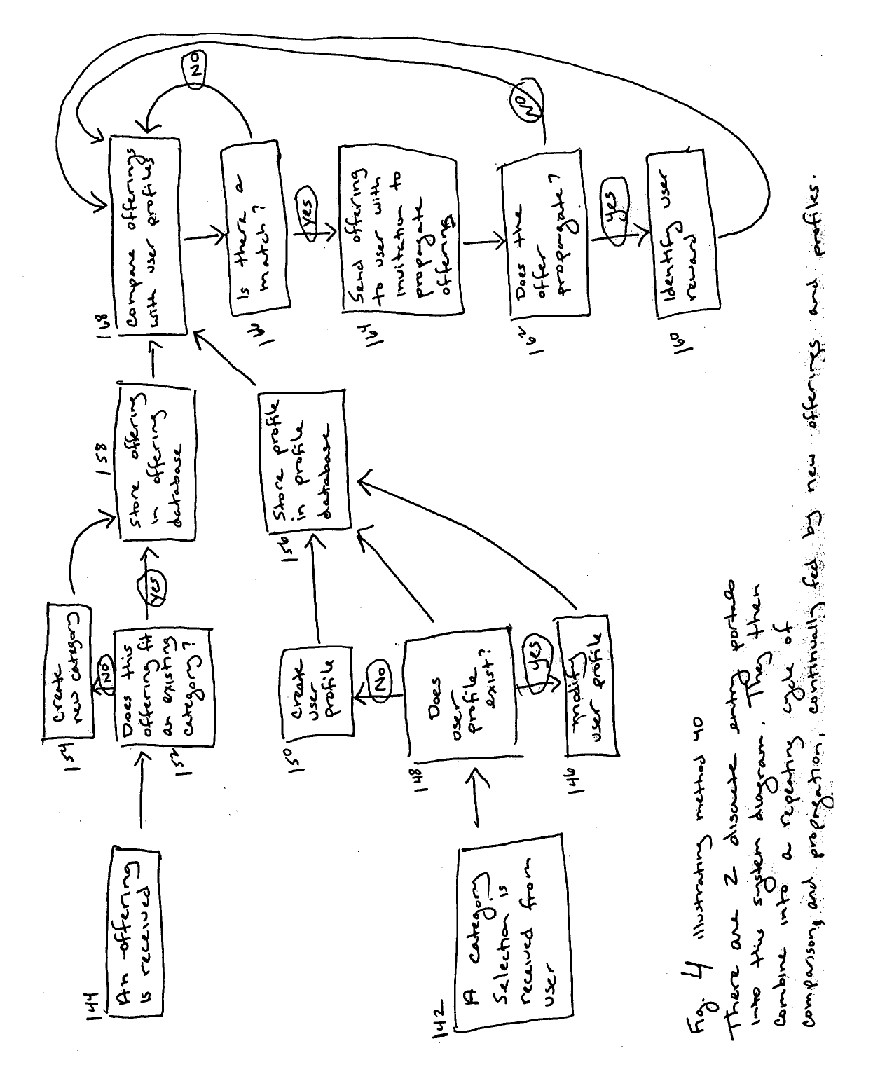

FIG. 4 is a flow chart illustrating a method 40 to facilitate computer-based commerce utilizing compounded e-mail, according to one exemplary embodiment of the present invention. There may be two distinct entry portals into the system, which combine into a repeating cycle of comparison and propagation, continually fed by new offerings and profiles. The compound e-mail system 10 receives a category selection from a user at operation 142. If the user profile exists at operation 148, the user profile is updated with the selected category at operation 148; otherwise the user profile is created at operation 150 and stored in the profiles database at operation 156.

When an offering is received from a provider at operation 144, the offering is assigned a category at operation 152 and stored in the offerings database at operation 158. If the offering does not correspond to any of the existing categories, a new category is created at operation 154. If it is determined at operations 166 and 168, that the offering category appears in the user profile, and if all other delivery criteria are met, the offering is sent to the user at operation 164.

When the offering is sent to the user at operation 164, the user is invited to send the offering to other people, if the user believes that the offering is of interest to them. If the user forwards the offering at operation 162, the user may be entitled to a reward. The reward is identified at operation 160 if, for example, the forwarded offering resulted in a sale.

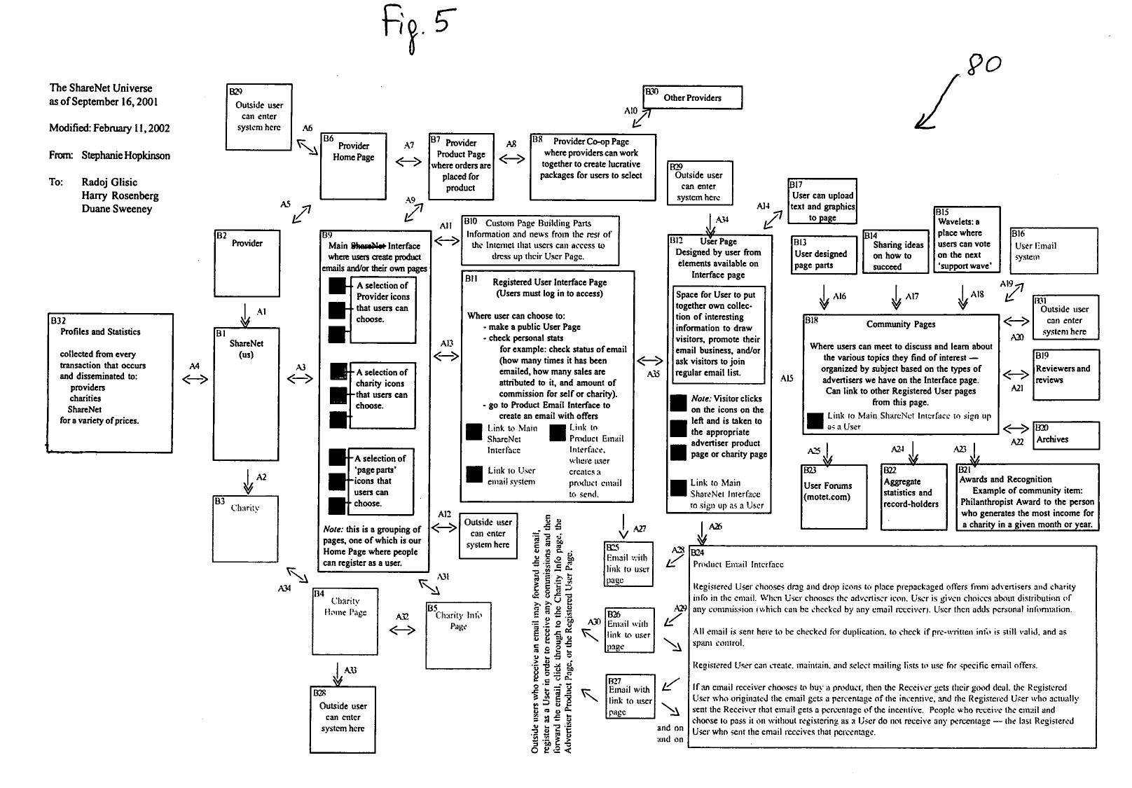

FIG. 5 is a block diagram illustrating components to facilitate interaction between different participants in a compound marketing system 80, according to one exemplary embodiment of the present invention. Referring to FIG. 4, block B1 is a compound marketing system manager. Block B2 is a provider. Block B3 is a charity. Block B4 is a charity home page. Block B5 is a charity information page. Block B6 is a provider home page. Block B7 is a provider product page where orders are placed for a product. Block B8 is a provider cooperative page where providers can work together to create lucrative packages for users to select. Block B9 is a main compound marketing system interface where users create product e-mails and/or their own pages. The main compound marketing system interface B9 may include a selection of provider icons that users can choose. The selection of provider icons may include a selection of charity icons, and a selection of ‘page parts’ icons. In one exemplary embodiment, this is a grouping of pages, one of which may be the compound marketing system manager home page where people can register as a user.

Block B10 is a custom page building parts. Information and news from the rest of the Internet can be accessed by users via main compound marketing system interface B9 to dress up their user page. Block B11 is a registered user interface page (users must log on to access), where a user can choose to make a public user page, or check personal statistics (e.g., how many times an offering has been e-mailed, how many sales are attributed to it, and amount of commission for self or charity ). At the registered user interface page B11, a user may also access a product e-mail interface to create an e-mail with offerings. Links to main compound marketing system interface B9, to user e-mail system B 16, and to product e-mail interface B24 (where user may create a product e-mail to send) are provided at the registered user interface page B11. Block B12 is a user page designed by user from elements available on interface page. The user page B12 may include space for a user to put together the user's own collection of interesting information to draw visitors, promote their e-mail business, and/or ask visitors to join regular e-mail list. Visitors may click on the icons within user page B12 and may access an appropriate advertiser product page or charity page. The user page B12 may include a link to main compound marketing system interface B9 to sign up as a user.

Block B13 is a user designed “page parts” page. Block B14 is a module to allow sharing of ideas. Block B15 a place where users can vote on the next ‘support wave’. Block B16 is a user e-mail system. At block B17 user can upload text and graphics to user page B12. Block B18 is a collection of community pages where users can meet to discuss and learn about the various topics they find of interest. The topics may be organized by subject matter based on the types of advertisers that appear on the main compound marketing system interface page B9. Community pages B18 may allow a user to link to the other registered users pages B11 from this page. Community pages B18 may include a link to main compound marketing system interface B9 to allow a user to sign up for a compound marketing service. Block B19 is an interface for reviewers and reviews. Block B20 is an archive. Block B21 is an awards and recognition module. The awards and recognition module may facilitate a community item, such as a philanthropist award to a person who generates the most income for a charity in a given month or year. Block B22 is to facilitate access to aggregate statistics and record-holders. Block B23 is a user forum to facilitate discussions among the users.

Block B24 is a product e-mail interface. A registered user may drag and drop icons to place prepackaged offerings from advertisers and charity information in the e-mail. When a user chooses the advertiser icon, the user is given choices regarding distributions of any rewards (e.g., commissions), which can be checked by any e-mail receiver. Users may add personal information to the e-mail. All e-mail is sent to the product e-mail interface B24 to be checked for duplication, to check if pre-written information is still valid, and as spam control. Registered users can create, maintain and select mailing lists to use for specific e-mail offerings via the product e-mail interface B24. If an e-mail recipient chooses to buy a product, then the registered user who originated the e-mail may be awarded a percentage of the incentive, and the registered user who actually sent the receiver the e-mail gets a percentage of the incentive. People who receive an e-mail and choose to pass it on without registering as a user do not receive any percentage—the last registered user who sent the e-mail may receive that percentage. However, an unregistered user who receives an e-mail may register as a user with the compound marketing system 80 prior to forwarding the e-mail, which may allow the user to receive a commission, as well as click through to the charity information page B5, the provider product page B7, or the registered users page B11.

Blocks B25, B26, and B27 are e-mail pages with links to the user page B12. Block B26 is an e-mail with link to user page. An outside user can enter the compound marketing system 80 via modules illustrated by blocks B28, B29, and B31. An outside provider can enter the compound marketing system 80 via a module illustrated by block B30. Block B32 is a profiles and statistics module to facilitate collecting profiles and statistics from every transaction that occurs and disseminating these profiles and statistics to providers, charities, and the compound marketing system manager B1 for a variety of prices.

Free E-mail

Free e-mail provided to anybody is an optional part of the compound e-mail system 10. In this mode any person can establish a free e-mail account, allowing them to send and receive e-mail, and to establish and maintain a database of potential recipients.

As is common practice, users of free e-mail may be exposed to various offerings and e-mail they send may include offerings or invitations or other information from the system, for example, in the form of listing the top few best selling items, or invitations to join the system to make money for a cause or individual one supports.

With no further action, such users may not be eligible to receive affiliate income, to send compound e-mails, or to access some other features of the system. However, they may be able to establish interest profiles, both positive and negative. This gives any user an opportunity to eliminate or screen all compound e-mails coming to him/her through this system.

By becoming an affiliate, a user may still receive free e-mail services and in addition gain access to a compound e-mail creation area and possibly other privileges. Higher levels of results from affiliates may garner them still higher levels of service, such as a larger e-mail storage space, advance notice of certain offerings, and official recognition in some fashion, such as the right to use a specific seal or symbol on their materials, and highlighted listings where appropriate.

Compound E-mail Creation Area

In one exemplary embodiment of the present invention, when affiliates log in, they gain access to facilities allowing them to create compound e-mails. These are e-mails that may contain their personal messages, and that may also include product or offering modules. These e-mails may also be coded by an affiliate, so that an e-mail can be tracked and any results of interest to the system, such as referral fees to be paid, may be communicated to a sender.

The compound e-mail system 10 may include a contact database with interest profiles; means for writing e-mails and optionally including voice and other types of communication; access to public parts of interest profiles created by anyone in the system; access to updates that are not public but are directed to an affiliate, either specifically as individuals or as a class, such as all those who have a particular e-mail address in their contact database. Means to inspect the offerings may be available for an affiliate to include in a compound e-mail. This could be a database of such offerings that they can search. It may include automatic notification of new offerings in their area(s) of interest. Means to attach to, include with, or reference by the affiliate's e-mail one or more offering modules may be provided in such a way as to track their contribution to the result desired by the provider. Access to a payee database of all potential payees available for public viewing, and means to select payees as recipients of all or part of any income or other benefits generated by a compound e-mail may be provided. This may include profiles of each payee to aid a viewer in making selections.

Other exemplary functions of the compound e-mail system 10 may include an access to a more limited and personal list of payees preferred by the affiliate, means to add or delete payees from this list, as well as means to combine personal messages and offering modules into a compound e-mail, and send it to selected individuals from a sender's database of recipients, or to others not in the database, and to direct benefits to payees as desired.

There may be a wizard or other automatic assistance available to help an affiliate to accomplish all necessary steps and to check that all have been accomplished before sending a compound e-mail.

Publisher Status

Another arrangement could be called “Publisher”. This includes all the access described for the compound e-mail creation area, and more. The arrangement may include access to a database of editorial content (e.g., free or fee-based); access to a database of writers, with whom arrangements can be made; a wizard to guide a process of creating a publication; more extensive tracking or display of results than is provided for compound e-mails; and other facilities determined to be helpful to publishers

A publisher may be allowed an alternate route to enter the compound e-mail system 10. In this case individuals (or companies) can create a product from other products. Using components supplied by the system and their contribution of selecting an attractive set of modules, along with any other value they are able to add such as reviews or other editorial, publishers may create a module including of all of the abovementioned as their original creation. This can then be released into the system in the usual way, with the publisher possibly having access to other services, such as subscription services. A publisher thus acts as a value-added reseller, in a sense, taking modules that could stand alone and combining them with others and/or with other material that makes them more interesting or attractive, or in some other way gives them an advantage that encourages their propagation.

A publication (a product of a publisher as just described) may produce two commissions, when there are commissions being paid. One commission may go to an affiliate who most immediately passed along the affiliate email and the other goes to the publisher. It may be that a provider sets these two reward levels, and that publishers may choose the modules to include with their content partially or wholly on the basis of what the commission is on the provider offerings on one or both of these levels. Or the system may give publishers the option of dividing the normal commission between themselves and the affiliate. Both the affiliate and the publisher are paid from the proceeds of sales or other desired actions generated by the compound e-mails, with the module part of the compound e-mail being a module of modules plus the publisher's added contribution of selection, arrangement, and additional content if any.

A publisher may be a user with a right granted by the system (whether by payment of a fee or otherwise) to create one or more publications, which may be but not limited to some combination of text, images, sounds, and so on, without limiting types of inclusions by these examples, that may also include commercial or noncommercial modules. This publication and modules included in it receive special tracking, with a portion of proceeds going to an affiliate passing it on, and another portion going to the publisher as compensation or reward for creating a publication that stimulated passing on of the module being responded to.

Publications can be products in themselves, such as a short story or even a functional computer program to which a key is provided upon payment, or freeware, shareware and the like. They can be anything of value that can be put into a form that can be transmitted through this system. As a product, they can pay an affiliate for a desired action, and a publisher in this case is the provider as well. When a publication is itself a product, the publication may be created either within or outside the system, but will be transformed into a module so it can pass through the system. In this sense there is little distinction between being a provider and a publisher, except that being a publisher is another route into the system and is more available to individuals than the commercial route which is oriented to companies. Using the system support provided to publishers, an individual could work themselves into a business, beginning with repackaging related modules, adding more content, adding more original content, and then creating the included modules entirely, as one possible development path.

Subscriptions to Publications

In one exemplary embodiment of the present invention, there may be a database of available publications, with user rankings and reviews, an ability to subscribe and unsubscribe in case of serial publications, an ability to contribute comments and ratings, and other ways to interact. The compound e-mail system 10 may be arranged to provide for anonymous subscriptions, so that a publisher may know a number of subscribers but not necessarily anything about them, including their e-mail addresses. This safe and confidential environment is an advantage to subscribers in that they need have no qualms about their e-mail address being abused, so long as the system as a whole is trusted. It is an advantage for a publisher for the same reason, to the extent that it removes a barrier to subscribing, and may therefore attract a larger number of subscribers than would otherwise be the case.

Tracking Results of Compound E-mails—What is Visible to Users

Non-affiliates are not permitted to track compound e-mails or associated information. Affiliates may, however, may track current and past earnings and payment status; various sorts of historic information; a number of e-mails they have sent, a number and/or percentage of the e-mails they sent that were forwarded, a total number of forwards through all generations; an amount earned for charities from their personal forwards from all forwards from them onwards, or altogether from the beginning of the sequence; a number of potentially profitable e-mails and forwards, including the ones that would have generated an income or other benefit to the affiliate if a purchase or other desired action had occurred; a number and percentage actually profitable; amounts paid to those in the payee profiles as total to date, year to date, and as a result of specific compound e-mails with their offering/payee combinations.

In one exemplary embodiment, the compound e-mail system 10 may provide feedback relating to the results generated by affiliates to allow them to improve on what they do if they choose to do so. The feedback may be used as a business analysis tool, and the system may provide such analysis.

The information provided to publishers may include the reach of their publications in terms of, for example, the number of affiliated emails sent, the number forwarded, and the number of generations of forwarding, all related to time; the number of subscribers gained and lost; a geographic map or breakdown representation of their circulation; feedback from readers or users; and a financial analysis of each publication

Tracking—Internal and for Providers

In one exemplary embodiment of the present invention, an internal management may be able to see all individual records, subject to security and privacy standards adopted by a system provider; automatic ranking of results by various factors; tracking of dissemination patterns as to speed, extent and other factors; geographic spread; and demographic analysis. The internal management may also be able to see correlated declared user interests with probable other interests based on interest patterns displayed by others; “real time” reports to providers on spread patterns, sales, etc.; historic reports on product categories; abuse complaints against affiliates and those on probation or expulsion; and total financial tracking, including payments to providers, affiliates and payees.

Community Pages

Community pages based on shared interests may be provided. These may be gathering places for people of similar interests and may include: product review and discussion; event calendars; personal connections; organization index (e.g., clubs, professional organizations, publications, etc.); access to personal pages of affiliate members and publishers; access to affiliated publications (those by publishers from within the system) with reviews and ratings of the publications by users; access to writings, articles etc. of relevance to the theme of a community page; access to news of interest; facilitating action as a group, such as all who want to choose a payee to support (e.g., an aspiring Olympic athlete, someone who is ill, etc.); education or access to education for novices to advanced; and entree to all the resources a community has to offer.

Personal Pages

Affiliates can have personal pages on which they state and show what they want about themselves and their interests. Here they may also link to products and offerings they endorse and can say why. They can do the same with payees they support. The system may provide the affiliates with elements to design their web page, and automatic assistance.

Publishers' personal pages may be highlighted in some way in lists or directories of personal pages. Here, or on publication pages to which they supply links from their personal pages, they can explain their focus in their publications, their background, list their archives, collect subscriptions, and so on.

Publication Pages

Any publication created by a publisher in this system can also have its own page (or more) describing it, allowing subscriptions and unsubscriptions, giving links to other publications, sites, individuals, products, etc., deemed relevant by the publisher, and showing reviews of the publication and ratings of various sorts by readers. Such pages could be part of more extensive online discussions, such as if they are the basis of or are connected to community pages. These publication pages may be listed in directories searchable by topic, author, rating, etc.

Providers

Providers are anyone with an offering being distributed by the system. This may be a large manufacturer or a small company, a shelter giving away puppies, or an individual selling or seeking something, whether for reward or not, or someone looking for a lost person, pet or item. This list is not meant to limit the uses, but to illustrate a representative range of uses. Providers may create an offering. In accordance with the requirements of the system, they create or have created module(s) that represent the offering, to be included in e-mails and publications. At the system operator's choice, payment to providers, if any, may come only from the system. This is to control “side deals” that may cut the system out of being paid for services rendered. Access to recipients contacting the source directly may optionally be channeled entirely through the system, so as to assure payment to the system and anonymity of the source (for privacy, protection from spam, etc.).

Non Profit and Not for Profit Organizations

Non profit and not for profit organizations may be payees. There may be a special class of payee designated, similar to a publisher, who receives a set percentage or amount from sales throughout all generations of propagation of a compound e-mail or publication. These organizations may be eligible for such treatment. They may be publishers of their own catalogs or other publications. These in turn may contain offering modules from anywhere in the system, or of their own creation. They may be providers, offering their own products, which may include memberships.

Seed Lists

At any level of specificity of product information (here “product information” stands for all types of information coming through the system) recipients may choose to put themselves on a “seed list.” This action assures that from that point on in time until they choose otherwise, they will receive information about all new products appearing in the system that are classified from that level of specificity downward (toward more specificity).

For example, a bicycle manufacturer may choose to put herself on the seed list for all modules related to bicycles because she wants to know everything that is happening in the world of bicycles. A mountain bike racer may put himself at a much more detailed level, being only interested in high-end mountain racing bikes.

Publishers in this system who are specializing in specific types of products or information will likely want to be on the seed lists for their specialty, as will others who have reasons to know everything going on in a particular sphere of interest.

If any persistent affiliations have been formed before a user joins a seed list, those persist until their normal expiration, even if the person on the seed list learns of a product and purchases it before the person with whom they are affiliated learns of it, being further down the chain of information distribution. There are various ways in which these lists can be treated. For example, these lists may receive the first announcement of any new module being released into the system if it is classified within the realm they indicated to be of interest to them. Membership of these lists may be kept confidential by the system, with the provider only learning their identity if they respond to an offering, and even then it will be up to the respondent to inform the provider if they are on the seed list or not.

The system may effectuate a charge for sending a module to this list, or it may make it mandatory that this list be sent the module if appropriate. If the system allows, a provider may choose not to use the seed list in favor of using no list Oust the announcing services of the system, or their own publicity) or their own list.

Persistent Affiliations

Certain offerings may include persistent affiliation as a feature and selling point, an inducement for affiliates to pass on their module. Persistent affiliation means that once a recipient responds to an offering to a level specified by a provider (inquiry, purchase, etc.), a respondent becomes persistently linked to the person who sent them the module in the first place. Thereafter the provider receives payment or other compensation for any activity in relation to this provider on the part of the respondent. This may be for a limited time, or have other limitations.

Reviewers

Individuals may put themselves on a list as potential product reviewers. These may be restricted to publishers with a demonstrated track record. Access to these reviewers may be direct, with the provider finding them through the system by looking for relevant publications and publishers, or the system administration may facilitate this access.

User Ratings of Products

A product or offering can have a rating page associated with it. On this page individuals can post reviews, assign numerical ratings, make comments, and so on. This would be a place for reviewers who are publishers in the system to make themselves known, as users coming to this area would be extremely self-selected, having chosen to research a particular item. Users interested in particular products or offerings could discover the review and other publications available through the system that are related to that product or activity area. Other related offerings could be available through searches from these pages, and/or through paid placement of links or other devices.

These rating pages could be moderated or unmoderated, however moderated is the preferred method so as to assure the quality and relevance of the posts. It may be that moderation would be a sought-after position by in-system publishers as it would give them additional credibility and visibility.

Providers may choose whether or not to have ratings pages, however it will be to their advantage to do so if they have a high quality product. Not having such a page will frustrate those who want more information, and may be taken as a sign that the provider does not trust what would be said. On the other hand, such a page would show up for anybody searching for that topic, and if strong support for the product were present on the page, it would be a powerful selling tool. Therefore it is likely that many providers of products or other offerings will find it to their advantage to have such pages.

Another effect of the existence of these pages is that such a public feedback system will tend to discourage poor products and weed them out of the market. Links to these ratings pages can be included in modules at the provider's choice. Publishers on a given topic area may be quick to post their reviews and comments on such a page for the reasons mentioned above (the opportunity for visibility, more subscribers, more sales and more affiliate income).

Ratings pages may be “pre-populated” with comments by using the reviewer network in advance of releasing the module into the propagation system. A presently preferred mode is to restrict content of the ratings pages to input from users of the system, with no input from the provider except perhaps to answer questions and the like.

The ratings pages may and preferably will be linked to an offering page, which is the provider's space to present what provider wants to communicate about the product. Preferably the Offering Page will also link to the ratings page for that offering. A numerical or other summary rating can be developed from the user ratings of each offering. This can appear in listings of products and offerings, so a searcher or browser can select various rating levels (for example, 70 or higher, 85 or higher, etc.) as one of their criteria. This system will again tend to drive high quality or good value products to the top of visibility and tend to eliminate poor quality products, or those with no ratings.

The same system can apply to publishers in the system, with comments from their readers, and rankings, visible to all. Transparency, that is, honest evaluation and making all relevant information freely available, may be achieved through ratings pages. The ratings pages may be applied in other contexts within the system as well as those mentioned here.

Payee Database

There may be a database of designated payees. Affiliates may choose to have part or all of the earnings from their activities assigned to any payee, including themselves. Payees may be organized by categories such as individuals and non profit organizations, under which there may be categories such as environmental, disaster relief, schools, and so on. This is an area where payees may present their stories, possibly with links to their outside web pages if they have them. The information from this database is what recipients of compound e-mails would see if they choose to get more information about the payee for a particular compound e-mail. Who gets paid and how much might well be a factor in their choosing whether or not to make a particular transaction, and may become a factor in the choices made while composing compound e-mails or publications from inside the system.

This degree of choice about what happens to the money a purchaser spends is unique to this system. The ability of an affiliate to select and combine products and payees is also unique. It opens the door to commercial possibilities that have not been possible before, such as magazines (online or off) that do not have to sell advertising, yet derive their income from products advertised. This database may be searchable by affiliates to facilitate finding of appropriate payees. Preferably if would allow the affiliates to easily attach a payee or multiple payees and the amount or percentage each payee is to receive to their compound e-mail. In line with the emphasis on privacy, payees may also choose to have their listings minimized or made invisible.

### Embodiment 1

Benefits to the Providers

This system may provide providers (e.g., vendors) with a way to target their precise market, to put their offering in front of the individuals most likely to be interested, to do so more inexpensively, quickly, thoroughly and effectively than through other mediums; and to avoid bothering those who do not wish to receive such information.

Up-to-the-minute aggregated market data: In addition to the direct benefit of selling a product, vendors would also benefit from the market data gathered by the hub. The accumulated data from purchasing records and the related participant profiles would provide a trove of market information, especially when combined with known figures for sales, speed of transmission, number of transmissions of an affiliated e-mail, and so on. The size and behavior of each niche would be known extremely accurately, and almost in real-time. The data could be constantly updated and trends could be followed easily over time. This level of market analysis is a source of major income (i.e., 7,564 telescopes at $395 sold in 14 days with 47,876 affiliated e-mails sent).

### Embodiment 2

Benefits to Participants

This system provides participants with a variety of benefits: great deals on products, instant information on products of interest, no spam (discussed below), funding for newsletters or magazines paid for by the companies the participant chooses, free e-mail service, contributing to charities, personal web pages, and opportunities for revenue.

The system is in fact a new publishing format, as newspapers or pamphlets were once new publishing formats. It is a format that (to a degree) puts the power of the “press” into the hands of the people.

### Embodiment 3

The Individual, Small Scale Affiliate Aspect.

Most affiliate programs are successful only for people who have websites with high traffic or who have large e-mail lists, like e-zines or newsletters. The affiliate raves about some new thing they have found and directs interested readers to use a specific link. Using this link marks the potential customer as ‘belonging’ to that affiliate, and at the same time takes the customer to a website selling the product. If there is a sale, then the referring affiliate gets the commission. It can only be successful if the affiliate spreads the word to many people, and then only if some of those people happen to be interested in what the affiliate is promoting.

In contrast, the present system helps participants send the information only to those others who are truly interested in that topic. Rather than focusing on marketing, this system encourages participants to focus on other people and their needs. People can be successful with this program by doing nothing more than they would do naturally—pass along a good piece of information to a friend.

These messages may or may not be commercial offerings—they may be news or other information, or requests, which makes this a publishing medium with a unique distribution system. Such a set of linkages among individuals has the potential to reach every person with that interest who has e-mail. Uniquely, nobody will necessarily know the identity of everyone in any distribution chain, yet every individual will have the correct and current information, and will be able to verify details, learn more, and interact with the authoritative central source to purchase or take other action. Think of a telephone tree where each person decides who to call with each message. Each person only knows who contacted them and whom they contacted.

Quality of content is also supported by the ability to disable further sending of, or action on, affiliated e-mails all over the world at any moment. This means that people can rely on the information in affiliated e-mails to be active and current, unlike that in e-mails, where the original author is often lost and the message can be changed by every user before it is passed on.

E-mail can travel the Internet forever, as urban legends demonstrate. The central hub design of the present invention reduces this possibility for an affiliated e-mail as described herein. An expired e-mail would no longer be sent on. There might be an explanatory e-mail that would go to everyone with an affiliated e-mail being killed or updated/replaced with a new version.

So information in an affiliated e-mail will come to be regarded as inherently of higher quality than that in e-mail, because of its currency and source transparency. This is possible because it comes directly from a central source which maintains control.

### Embodiment 4

Paying Clients

Vendors selling unique products to niche markets would be the model clients for this service, and perhaps the mainstay clients. Niche products are of high interest and value to some people but not to most people, yet most people participate in one or more niche markets. By focusing on the ‘niche of niche marketing’ the present invention serves most of the population at one time or another. Vendors would pay for access to customers, as with any advertising medium, and pay for the highly customized marketing data as well.

Niche products can be expensive and difficult to market, for their target audience is often thinly scattered and hard to identify, with specialized publications or gatherings the best means of reaching them. This system provides a way and incentives for people who share specific interests to meet with each other efficiently, through e-mail, and to pass along interesting messages to others in that group. This process of self-selection and identification results in greater loyalty from the participants, leading to more sales for the vendors.

### Embodiment 5

Reclaimed Tropical Hardwoods

This embodiment is to show how this system would work for very specialized and industrial markets.

Imagine a vendor has a source for container loads of reclaimed tropical hardwoods, cut from railroad ties that have been replaced in an Asian country, which may be used for tongue and groove flooring and the like. The selling price of a container of this material might be about $17,000. Likely, there are few people looking for such an item, but it may very well be interesting to a small number of consumers.

How does the vendor find them, since the vendor is not in that industry? Using the methods being discussed herein, the vendor may start with a seed list. The vendor can find a few prospects in a magazine, Fine Homebuilding, and on the Internet; about 15 or 20 companies in all, in related fields, some directly related. The vendor may send these “seed recipients” an e-mail offering a commission of, for example, $500 for each container sold to someone they recommend, for a year, however many that is. There is created, through the present invention, a website with the relevant information, and a link to it in the e-mail sent by the vendor. Everybody has to register to see the website. Registration identifies them. The person sending the e-mail (the vendor) has already registered as an affiliate and the present invention tracks this sending to know they get credit if one of their contacts becomes a customer. When the process is completed, a diagram of the connectedness and population of this entire niche with e-mails and names may be generated. Other information may be accumulated as well (e.g., company and other contact info, at least, so rewards can be distributed).

The few people the vendor sends this e-mail to will know others in their industry, and will have every reason to pass it on or use it themselves. They, or the people they send the e-mail to, or the people those people send the e-mail to will eventually reach a large number of potential buyers of this product.

### Embodiment 6

Central Coordination Hub

Vendors (e.g., the original companies manufacturing or actually selling the product) can enter the central coordination hub in a variety of ways. They can insert single offerings into the e-mail distribution system or compile offerings into Internet publications, or create websites that collect particular selections of offerings from only themselves. Vendors can build web pages for specific products, for a line of products, or as an extension of their independent web catalog. Others can take the role of aggregators and resellers, collecting related offerings into Internet publications or websites.

### Embodiment 7

Cash Flow

There is a cash flow advantage in this system in that the service can charge on a per order or per lead basis, minimizing upfront costs and risk for the provider, while placing no upper limit on system earnings. Providers can also access up-to-the-minute, focused, and highly accurate marketing information on almost any area of consumer interest.

Participants can enter the central coordination hub by clicking through on an e-mail message from another participant, by visiting the community pages, or by accessing the main interface page. Once registered, a participant can generate an e-mail through the product e-mail interface B24 using the participant's own information and product offerings from providers. Participants can also build a web page with provider offerings and information of interest; and check their personal statistics, such as how many times a certain e-mail has been forwarded, how many sales are attributed to each e-mail, and the amount of commission generated for self or for a charity or other third party or parties. Participants can also visit the community pages, where they can meet to discuss and learn about various topics of interest, including specific products or classes of product, share ideas on how to succeed with affiliated e-mail, discuss topics of concern and generate the next ‘support wave’ (discussed later), check out reviews of products or subscribe to a specific reviewers list, check out archives, participate in the awards and recognition program, check aggregate statistics and record-holders of other participants, and visit user forums.

### Embodiment 8

Product E-mail Interface

Providers create drag and drop icons of offerings that participants can then insert into their e-mails. These icons contain links back to provider product pages B7 and B8, where recipients of the e-mail can peruse the sales message and purchase items.

Participants create e-mails using their own information and the offering icons. Profiles created by recipients prevent them from sending unwanted e-mails. Profiles of their contacts that affiliated participants create allow them to target specific groups with information and product offerings they think will be of interest. Participants can create, maintain, and select their own mailing lists from their own personal databases (an advance over “address books”) to use for specific e-mail offerings. E-mails are tracked, and purchases made by recipients of the e-mail are credited to the immediately preceding sender, and that credit can be applied to the sender, buyer, a charity, or wherever the sender wishes.

It may be that an affiliated e-mail can be forwarded by a person who is not an affiliate. In this case the commission on a sale is earned by the first affiliate “upstream.”

The flow of forwarding, affiliation and purchases is tracked carefully by the central coordination hub so that affiliates can be paid and so that the service gets its share of any per sale or per contact arrangement. The interest profiles contain potentially highly sensitive information and are highly proprietary and protected. Every e-mail containing an offering is coded as to subject matter, and checked against the interest profile of every person it is addressed to verify that it is acceptable to them. Every coded e-mail is sent from the hub, with the offering portion included afresh in the e-mail so it is always accurate and current.

### Embodiment 9

Compound E-mail and its Relationship to the Central Coordination Hub

The system does not necessarily require a website or an e-mail newsletter but is something anyone with e-mail could use, passing messages directly to specific people known to the sender who are likely prospects for the offering. These sales or other messages are to be sent to people already known and with whom there is a relationship. A personal e-mail about a product from a known acquaintance or friend is also a powerful recommendation, more likely to be read receptively than a message through other media. Other factors such as celebrity or expert status of the communicator come into play as well, and can be incorporated.

Compound e-mail according to present invention has a personal section written by the sender and it also has a part the sender cannot affect: the provider offering, which is included anew in refreshed, current form each time an e-mail is sent to a new person through the hub. The provider offering can include a sales message, a link to a site with the sales message, or a link to the transaction site. Because this e-mail is managed through the central coordination hub, provider messages can be modified within the e-mail every time it is sent through the hub. This allows for completely up-to-the-second updated information to be transmitted from seller to buyer. Because the sales message is renewed each time from the hub it works for limited time offerings, or for publications in which the content may have been updated, and would stop propagating whenever the hub was instructed to stop sending that particular message.

A person receiving an affiliated e-mail promoting a product they like, and wanting to forward it to a friend, could write a personal message to that person. When they send the e-mail, it first goes to the hub. The hub records who sent the e-mail and to whom it was sent so the sender get sales credit if a sale results, checks to make sure the receiver's profile allows for provider messages of this type to be received, checks to make sure the receiver has not received their limit on copies of the same offering (in accordance with settings they have made on how many to receive, and from whom), checks to make sure the receiver has not blocked e-mail from this sender, adds or modifies the provider offering as currently instructed, and then sends the e-mail to the receiver. In fact, the hub could track who has received a specific offering and send revisions or follow up offerings, if the originator desired and if the recipient opted for it (such as with air fares to a favorite destination, new music from a favorite group, books from an author or publisher, etc.; in this way it becomes a way to follow interests closely and get advance deals, such as prepublication prices). Instructions for sending an affiliated e-mail on to more people, as well as information about how to join the system as an affiliate, are included in the offering, so that every message sent can grow the system. Participants could be offered credit for every new affiliate who joins as a result of an e-mail they send out.

The process can repeat until a large number of e-mail-connected individuals and companies potentially interested in that product have been contacted, each of them one time only, and from someone who knows them personally. It is anticipated that this will become a comprehensive Internet based e-mail service of choice for many people, as there will be advantages unavailable from other such services (such as making money by sending e-mails, or earning money for one's favorite charities by sending e-mails, and the power and convenience of one's own personal contact database).

### Embodiment 10

Profile Updates

As interests change users may update their profiles and no longer receive information about certain products/services. For example, if a user is interested in telescopes but moves to a location where star gazing is difficult, the user need only change her profile and all senders who had the user initially indicated as being interested in telescopes would no longer see the user's name associated with that topic (if the user chose to make that information public) The user would automatically and instantly stop receiving affiliated e-mails about telescopes. The user may choose to keep certain information private. Then whether or not the user's name is properly connected with a particular interest in his/her contact list, the hub would prevent the user from receiving any e-mails on a topic that was removed from the user's profile. Thus there are two sets of profiles. The recipient makes one, which controls what the recipient receives. The sender makes a collection of profiles of what they think their contacts are interested in, based on their information and feedback. The two do not have to match. There can be inaccuracy on the sender's part, because the hub protects all recipients in accord with their wishes.

### Embodiment 11

Seed Lists

The compound marketing system 80 may utilize seed lists of people who have indicated an interest in particular topics to begin the communication cycle with each new offering or other communication. A charge may be applied for use of these seed lists. The seed lists may be compiled from the “interest profiles” associated with the users.

### Embodiment 12

Profiles Provide Opted-in Seed Lists

The e-mail service might be free but relatively basic for someone who has not provided a profile of their preferences, but in return for providing a profile a person may receive a higher level of service, such as protection from duplicates, ability to block categories of affiliated e-mail, participation in the profits of forwarding e-mail and other advanced services. These profiles are one source of the seed lists (if the members allow this use). The use of seed lists is something the operator of the present system could sell, though the provider would never see the contact information. The seed lists are the original lists a provider's message is sent to, to initiate the chain reaction.

Advantages of being on the seed list are:
1. One is in the first group to hear of a new offering (and some people just like to be first, and “in the know” in their areas of interest).
2. With the one copy standard, being on the seed list puts one in the best position to pass it on to make money, before others reach a particular person.
3. One will see everything passing through the system in the categories one has chosen.
   This is valuable for professionals, reviewers, merchants, competitors, enthusiasts, fanatics, fans, and others who have a need for complete information.

Having received an affiliated e-mail, but not being an affiliate, a person interested in a product can click on the offering and go to the provider site (which may or may not be on associated with the present system). They learn about the product, and can sign up and send an affiliated e-mail, as easy as any other e-mail, to friends and relatives who might appreciate learning about it. By sending the affiliated e-mail to their connections they inform the recipients of product, they may save the recipient some money over a straight retail purchase through a person-to-person discount (not essential to the present system, but possible sales inducement), and they make some money for themselves or for some person or group they care about.

Altogether this is a powerful set of incentives to join and participate. Even more powerful, in the full system, an individual could assign the money he/she would make to a third party, which could be a charity or other cause, or any individual, including the recipient of the e-mail as a second layer of benefit to him/her. Then the people who get their affiliated e-mail can do the same.

### Embodiment 13

One Copy per Recipient

The compound marketing system 80 may be configured to prevent anyone who is registered from receiving more than one copy of a particular affiliated e-mail if that setting were chosen, avoiding another potential annoyance. Avoiding getting more than one copy and avoiding off-topic affiliated e-mails would be a good reason for many people to register. This approach fits the “ethic” of the Internet, respects persons in a way “interruption-based” advertising cannot, and ensures that every contact is at least passively, if not actively, welcome.

### Embodiment 14

Prompt Forwarding

Knowing the one-copy-per-recipient system is in operation, some people at least would be very prompt in forwarding affiliated e-mails to their contacts if the income mattered to them, or if they just like being first. This tendency will help speed messages through the system.

Pattern establishment will also help. This can be facilitated by setting up a more sophisticated address book system than is commonly used, which would allow the user to assign any one person they know to any number of interest categories for easy mass forwarding of relevant e-mails. The system could allow personalization of e-mails as well, inserting names and other relevant details from the database.

As the system becomes increasingly established, that is, as growing numbers of people learn to forward affiliated e-mails and adopt the practice, as they settle on who they forward them to and as they assemble their lists of individuals in the hub database, more and more of the possible universe of contacts will be incorporated into the messaging network.

With data-based forwarding in terms of interest-based contact groups and with automated forwarding from trusted sources, a new and attractive product falling into this system is likely to be exposed to its entire online market in a matter of days.

### Embodiment 15

Contact Database Analysis:

Another consequence of central management of the e-mail would be that the compound marketing system 80 could maintain a database of the sender's contacts with all their known preferences and interests, for the sender's convenience and possibly to automate forwarding of offerings. It may be similar to an address book other e-mail hosts provide, but much more elaborate—really more like a client relationship manager/contact manager with numerous data fields of preferences and restrictions, possibly including an automatically compiled history of previous reactions (purchases, no responses, passed along the affiliated e-mail) and a record of the feedback messages received in response to previous affiliated e-mails. This allows the sender to truly fine-tune who gets what from their side. Some of the information will not match up with what is in the recipient's own profile that they construct, which is private, but that is ok.

A system can also be built in that allows a recipient to message a sender to refine their preferences: Not all bikes, just tandem bikes. Senders with the best relationships with recipients would have the most accurate databases. Senders with poor relationships would just get blocked.

A potential development is that a link in the affiliated e-mail connects the user to their address database to help them forward to the relevant entries they have made. The database ranks entries by the interest codes the user has associated with each user, indicating which are likely to be responsive to a particular offering. Intelligent agent software can analyze response patterns to identify which members might be open to new offerings, based on patterns observed for other people.

### Embodiment 16

Contact Level 1: Full Contact

One option would be to sign up directly to receive everything in one or more product areas. One would do this if they were either very interested about something (or simply wanted a lot of e-mail), or if they were studying a market sector, or if they were a retailer in that field, or if they wanted to act as a filter, picking the best and passing that on, intending to make an income from sales based on their discrimination and taste, and for other reasons.

Followers interested in disseminating information could send out regular e-mags (defined below). Their ratings from readers could be posted so new people looking for a guru could find the best. The top people would become very influential in their spheres and could make very good incomes. They would receive review samples of the kind of material they work with. It could be mountaineering equipment, or fly fishing gear, or a genre of books or music.

### Embodiment 17

Contact Level 2: Filtered Contact

Someone who wanted to know only about what was good, filtered by someone with similar or better taste, would search the user evaluations of the interest area gurus in their interest area, read the promising-sounding e-mags posted online, find one that is compatible with their interests, and subscribe. They would know the person is getting money from their purchases. It is a conflict of interest but integrity in reviewing would be rewarded with the loyalty of their readers.

### Embodiment 18

Automatic Affiliation by Forwarding:

Another consequence of central management is that a person could be automatically signed up as an affiliate by the act of forwarding an affiliated e-mail to someone. This minimizes the question of whether or not to become an affiliate. The main question for the user becomes, do I know someone who would like this? And send it to them. In the process of sending they would be taken to the hub where the minimum necessary information would be collected and they would become an affiliate.

### Embodiment 19

Forward Without Affiliation:

Someone receiving an e-mail can register or simply pass it on, by refusing the option to become an affiliate, leaving the person they got it from as the registered affiliate. In this case the registered affiliate will get any benefit until they are replaced.

### Embodiment 20

Persistent Affiliation:

Here is another incentive to pass on an affiliated e-mail. Say user 1 sends an affiliate e-mail to user 2, and user 2 visits the associated website but does not buy the product. Later, suppose user 2 does buy something from that website, but a different item than was in the affiliated e-mail. The incentive program could include a feature so that if someone once registered to user 1 for a particular company makes a purchase at any time, user 1 gets a commission. This would last until the buyer went to the website from a link in another affiliated e-mail provided by somebody else. The most recent referrer gets the credit. There can be any time limit desired, from one visit only to a month, a year, or forever. This ups the reward potential for sending affiliated e-mails on, and therefore the speed with which a good product will saturate its potential market.

### Embodiment 21

Authentication:

Another feature of the present invention is authentication of the sender, and source attribution. It would be easy to sabotage a politician, for instance, by putting out a phony affiliated e-mail that misrepresented that individual's positions or rating history, or to manipulate the stock of a company, or to put out any number of traps for the unwary. So the ability to kill affiliated e-mails at any time, even on the user's computer, and to stop their spread through the Internet would be desirable. Having the source of the affiliated e-mail apparent and independently verifiable by the receiver (before downloading) is another benefit provided by the present invention.

### Embodiment 22

Privacy:

The compounded marketing system 80 may include mechanisms to ensure the user's privacy.

### Embodiment 23

Public Product Evaluations by Users:

Another quality control feature of the present invention is an optional service allowing members of the affiliated e-mail or of the product(s) it represents to post their product evaluations and comments. This feature would be optional for the provider to provide (at a cost, of course), but those who do allow such open evaluation would gain credibility, assuming the evaluations are good. The dynamic would be that products with bad evaluations would tend to fail, and products not allowing public evaluations would tend to be ignored in favor of those that did.

Affiliated e-mails in a category could be viewed by an interested person and ranked numerically or in 4 star, 5 star etc. categories by the evaluations they received from users, with another category of ‘no rating’ for new products.

This public product evaluation would be another source of credibility for the system as a whole as well as for individual products, and a powerful draw to using it for shopping for physical products, services or information. It would also be a valuable source of feedback for the company selling the product and for new product designers to help identify unmet needs and needed improvements.

### Embodiment 24

Transparent Arrangements (in Two Senses):

The back end functionality is basically invisible to the participants. However, the terms of the arrangement may be clearly stated in the affiliated e-mail (what the commission is, and that there is a commission, etc.), and the source that sent it to them.

There can be a link in each affiliated e-mail to click where someone can provide more information about themselves, including who they assign earnings to, and what their background in that area is. This link might also take a user to the personal web page the sender has created on the system, which in turn would detail their interests and the products they have affiliated themselves with. Following these links could be a very effective way of finding compatible people, discovering more about people one knows already, and finding communities of interest.

Each individual may have their personal records available online to them, showing what they sold, how much was earned, and who was credited with how much. For charity projects it can show the results several generations deep, showing the cumulative effects of their participation, to encourage them to continue.

### Embodiment 25

Automated Forwarding:

When individuals find someone who consistently sends them quality information or offerings they can choose to automatically get anything that person sends out, relevant to their interests. A music reviewer for a favorite type of music, for example may be set up on the system to allow “subscriptions,” that others can join to automatically get everything sent out under a certain code by the reviewer. If these are affiliated e-mails and as the “publisher” the reviewer gets paid for every purchase, she/he has a real incentive to do a good job. This may thus become a niche in the publishing profession.

### Embodiment 26

SPAM

The compound marketing system 80 may be configured to inhibit unwanted e-mails. To start, there may be a firm no-spam policy stated in the beginning of each affiliated e-mail. Then if a person getting an affiliated e-mail feels it was spammed to them they can do several things that will prevent repetition:
1. Timeouts and banishment
2. Feedback from receiver to sender
3. User profiles
   Spam Prevention 1: Timeouts and Banishment

Spam complaints to the hub can result in giving the sender a time-out on collecting any commissions (make them lose commissions on any sales that happen from anyone they sent the affiliated e-mail to, for any period of time, which would escalate with repeated offenses to permanent banishment, perhaps). It could be a temporary ban on sending any affiliated e-mail at all (without affecting their personal e-mail).

Spam Prevention 2: Feedback to Sender

Users may “educate” the system about what they are interested in getting. There may be four levels:
1. Send more like this;
2. Refine the selection (I never buy this brand, but others are fine);
3. Drop this topic, as my interests have changed, or I have other sources I prefer.
4. Never send me anything again period because I find what you send me of no interest.

This filtering is maintained in the user's personal profile, which is checked every time someone wants to send an e-mail to them and blocks or sends as requested. Each e-mail is coded with the relevant information so it can be compared to the requirements of the profile.

Means for providing this feedback not only to the hub in terms of updating the personal profile that it checks, but to the senders of affiliated e-mails as well may be provided. For example, a form (reached by a link) built into each of the affiliated e-mails soliciting these types of comments, and sending them as a reply to the originating person can be used. This form could be the mechanism for educating the hub about evolving preferences, and could at the option of the receiver be sent to the originator of the e-mail and to anyone else in his/her contact database.

It would be very effective if this feedback reached into all sender contact databases and updated the receiver's profile thereon, so the sender's record is automatically accurate. Thus if several people know a user has an interest in toy trains, but the user suddenly becomes interested only in antique toy trains, the user can update everybody at once. This keeps the senders from the effort of sending the user now-irrelevant e-mails, keeps the user from receiving any such e-mails, and puts the senders on notice to be alert for anything about antique toy trains that the user might want to know about, thus improving the quality of information and the efficiency of associated actions.

Spam Prevention 3: Profile Management

All affiliated e-mails are sent through the hub. Everybody, affiliated or not, and no matter who provides their e-mail, may create a profile on the hub to control the e-mail they receive through this system. They may opt out altogether and get no commercial e-mails, or they may set conditions as to who may send it to them, excluding specific individuals (or their e-mail addresses), topics that are not acceptable, topics that are particularly sought, the maximum number of copies they want to get, and other parameters as may arise. This way, users can protect themselves from receiving unwanted messages, as well as ensure that they receive the messages they do want.

This profile would not be public unless the user chose to make portions of it public. Members can have, for instance, personal websites on this system that are designed to be about interests they may share with others. On these sites they can recommend the products they endorse, host discussions, etc. This is one place public portions of their profiles could be shared.

Any affiliated e-mails sent via the system are checked against the profile of the recipient to determine if the recipient has restricted what she/he is willing to receive. This is known in the direct mail industry as a nixie list.

One consequence of this system is that while one could resist creating a profile, one would then be subject to getting more unwanted affiliated e-mails. In this sense it is somewhat coercive, and may have many people participating if only out of “self-defense”. Minimizing the fallout from this aspect will be important. One way to do this is to put the option of opting out with each of the affiliated e-mails in the form of a link. This would take the person to a page that would present the case for staying involved and give them several options. They could opt out at any level, from the smallest subcategory that included the e-mail they are responding to, to opting out of higher levels of category, to altogether, meaning “no commercial e-mails.” They could set up or alter their profile in any way from this page, updating it as they go along getting affiliated e-mails, fine tuning it to suit them at any given time.

Spam Prevention 4: A General Spam Control System Using Required Codes on Commercial E-mails

The present approach of coding e-mails that contain offerings so that any specific topic or related set of topics can be screened out or actively chosen by the recipient is central to the functioning of this system.

This coding raises the possibility of another application that could benefit all e-mail users, a generalized anti-spam system.

Anti-spam filters may at present look for keywords, or for specific senders, and block those e-mails. However, this may also block e-mail that is not spam.

Recipients, depending on their e-mail service or program, can block specific senders. This is useful but incomplete, as it can happen only after the fact, and takes effort and time on each new occasion.

Certain groups have taken it on themselves to interfere with Internet access for companies they deem as spammers, or even having their systems set so they can be utilized by spammers without the companies' knowledge. This is an arbitrary and potentially very damaging and expensive experience for such companies, who may not be informed of why their Internet service has been denied nor how to get it back. Eliminating the perceived need for and the activities of such organizations would be another benefit of an efficient and effective general spam control system.

Lists of senders identified as regular sources of spam are maintained by e-mail services and transmission of e-mail from these sources is blocked. This does not serve people not on their system, it may be unfair to the senders, and it is non-selective by the intended recipients.

The coding approach proposed in this invention could form the basis for protecting individuals from unwanted commercial e-mail in a more comprehensive, organized way, while (in one embodiment) allowing individuals to continue to receive commercial e-mails that may be of interest to them.

### Example 1

One embodiment of this approach provides only a negative screen.

That is to require such codes, which could be simple alphanumeric strings, to be included in the subject line of each e-mail that contains an offering or suggestion that one purchase something. Existing e-mail programs could then be set to block e-mails with specific codes.

Thus one could set his/her e-mail to block any e-mail having anything to do with mortgage rates, pornography, work-at-home opportunities, legal aid services, and anything else the user does not want to know about at this time through this channel. Conceivably, one could potentially block all commercial e-mail with a single selection.

### Example 2

For users that do not want to block all commercial e-mail, but do want to block some or most of it coding would make it possible to ban all unwanted e-mail, with exceptions as desired for particular sub-topics that would be allowed through.

### Example 3

Existing e-mail services and programs will block e-mails with specific content in the subject line, so these would be adequate for the negative filter approach presuming a hierarchical coding system. For instance, all commercial e-mail codes may begin with COMM: (followed by more specific codes as to topic). Thus the program could block all e-mails with that content in the subject line.

The corresponding aspect of Example 2, which allows more selectivity, is Embodiment 3 on the recipient side: E-mail services and programs that block topics in a hierarchical organization of topics and at the same time allow specific exceptions, both as designated by the user.

With either Example 1 or Examples 2 and 3 together available, all e-mail containing a commercial offering and coded in such a way to go identify them could be filtered by the criteria set by the intended recipient and blocked or sent based on the results.

Commercial possibilities exist in creating and providing the schema for coding, charging for use of codes, for the service of determining proper codes, monitoring coding and e-mails sent to detect attempts to slip e-mail through the filter with false coding, providing and charging for the service of collecting and maintaining user profiles if it is a centralized system, then checking and sending the e-mails. E-mail programs and services could be charged a license fee for using the coding system and for providing Example 3, the software feature that allows exceptions.

Any or all of this classification and screening of commercial e-mails for acceptability to the user based on their expressed interests could be licensed to others, including existing e-mail service providers. Letting users screen out spam is an attractive benefit, and all the larger e-mail service providers might feel compelled to participate once one of them did.

### Embodiment 27

Grassroots Political Activity:

E-mail alerts regarding political issues are a common occurrence. The present invention allows for such alerts to be received or not according to a user's profile.

Politicians: Politicians could put their positions out at length, unrestrained by printing, postage, or other media costs and limitations, and have them distributed widely. A speech or video or even an ad could be propagated in an affiliated e-mail that connects to the website where it can be heard and seen. This is pure campaigning, with no money made from passing it on, just political speech.

Another feature of the invention is to provide means for a particular piece of information or offering to seep through the social fabric of society along particular threads of connection through peer-to-peer forwarding until everyone connected to those threads is informed and invited to participate.

### Embodiment 28

Nonprofit or Charity Fundraisers:

Charitable or non-profit organizations can be set as the permanent beneficiary of a particular offering or product, to which all the commissions or referral fees are directed, so the affiliated e-mail gets passed along because the product is good, and because it is a way to help the charity.

The organization (e.g., Make a Wish) may start by sending the email to all its current supporters for which it has e-mail addresses who send it to everyone they think would like that product. It could be any product, sold through any retailer online, and a certain amount from the sale would go to the sponsoring organization for every sale tracked through the affiliate software. People can respond and become identified by the charity as recipients of future offers it sponsors, thus increasing the effectiveness of future iterations with other products.

### Embodiment 29

Participants Choose a Charity:

For affiliated e-mails in which there is no fixed earning entity such as Make a Wish in the above example, there could be a list of charities and non-profits, even schools, on the affiliate management site, so that anybody registering as an affiliate can click a box and direct all their earnings to any charity or nonprofit on the list, from the Humane Society to Oxfam, Amnesty International to Harvard University, or their local PTA. As stated before, there would also be a mechanism for adding organizations to the list.

### Embodiment 30

Redirect Earnings to Anybody

Commissions could be directed to anybody at all. Aunt Sara could choose to direct any money she makes to little Elisabeth's college fund. All that has to happen is that someone put the required contact information on the database. Aunt Sara can put Elisabeth on that list and anyone wanting to donate money to her can designate her as the recipient of any credits earned. The money can be directly deposited to an account, or sent as a check, for example..

Obviously this list of potential recipients could grow very large, so it will have to be categorized and database driven. Nonprofits and all others can add themselves to the list. The possibility for fraud would be large, so some authentication system would be important as well, potentially.

Using profiles, any commissions could be directed to a charity, as above, or to any individual, as immediately above. The profile setting could also redirect the commission to the buyer, the recipient of the affiliated e-mail. This would remove the taint some people would feel about recommending a product to a friend while standing to make money. That circumstance would introduce a commercial element to the relationship they might not like, so they might not participate at all. Setting the commission to be earned by the friend receiving the message would amount to a gift, and assure that the recommendation was objective. If a person has a number of people they want to forward a commercial message to in this way, the profile could be set to “buyer gets commission” to make that automatic for all.

### Embodiment 31

Waves of Support:

When there is a disaster somewhere, the Red Cross (for example) can set up an account and everybody who wants to can log in and direct their earnings to that account. The same holds true for anybody who has a big problem that gets publicity, like a major disease or a fire—they can become the designated “reward recipient” for everybody who wants to help and is already redirecting their earnings from affiliate sales. It would develop into waves of support that could be directed to any particular beneficiary.

One aspect of affiliate programs that builds trust and enthusiasm, and that cuts down on administration costs, is that the affiliate can log on and see exactly how much they have earned in real time. They can get an e-mail every time a purchase is made that credits them. They could track how much they were responsible for generating for a charity (perhaps tracked through many levels to show the cumulative effect).

Annual awards for charity donations: Awards can be given with great fanfare, widely publicized, for the person who earned the most money for charity. This may encourage more organizations and individuals to take part. Each charity can make awards to the top earners in its own organization. Monthly lists and tips on how to be successful (an e-zine) can be circulated to those who are interested. This would help keep people aware of the value of this approach and draw other charities into participating.

Members can change their beneficiary at any time, redirecting their earnings as they please. This ability to partially control the stream of commerce—independently of what the company selling the product may have set up—is a feature of this system.

### Embodiment 32

Custom Compilations

An affiliated e-mail compiler that allows a user to create their own custom affiliated e-mail by clicking on ad modules they want included, one module per product may be provided. A module is the ad or description of the offering. The top-level provider makes these modules and pays to have them available on the hub, accessible to registered users. There may be several modules of different sizes and degrees of thoroughness for a single product, ranging from a large file with animation to a single page or a simple link to the relevant website, to suit the needs of the person assembling their custom affiliated e-mail publication.

With modules for each product, and templates for the affiliated e-mail compiler, a person or group could create their own collection of products (along with editorial and other material of interest) by selecting from lists of products. This could be an individual with good taste, a nonprofit group offering either a selective choice of products related to their mission, or any selection of things their members would be likely to buy in any case, but this allows them to divert the some or all of the commission money to the group.

Celebrities: Imagine golfers having a professional player tell them about a new golf glove he thinks is great. Would they read that? Would they buy it? Very likely. If the player has created a large e-mail following he can do this directly already, but it is not very dignified. Or, using the seed list concept, the player can write his affiliated e-mail (or have someone do it for him), send it to any appropriate list at hand, and let it spread with no further effort. This is the relationship of celebrity sponsor, and it can be written in the third person, with quotes, or as a direct pitch if the celebrity really wants to put his/her personal stamp on it. As the celebrity sponsor the system can be set up so that he receives a reward for every desired action, and each person responsible for connecting to someone who buys gets the usual commission as well.

This channel can also be much more extensive and personal than other media, with links to websites devoted to filling out the experience of the affiliated e-mail, such as updates, chat rooms with other members or people considering the purchase, where you can talk or listen in on live chats with the expert or celebrity.

When the networks of connection are fully evolved and automated the ability of a group to spread the word about something would also be huge, making this the preferred medium for promoting events and other time sensitive information.

Experts: Of course a person sending an e-mail about a product or service could know a lot of people, or have a lot of people who respect their opinion in some area of culture or expertise, like bass fishing. Maybe they write for a magazine, or a website, have an ezine, or have written a book, or have a TV show, or are a celebrity in their field in some other way. They could reach a lot of people who would respect their opinion and who would be delighted to be getting e-mail from them telling them about their favorite new things. This becomes a new income source for anyone with a circle of influence.

Personalized Gift Catalogs With Discounts: Someone could pick a ready-made or compile a special gift catalog for an individual person, and include a credit toward any purchase—basically a gift certificate to a store designed for that person. The gift could be money deposited as a credit to that person's account, so they could spend it any way they want, or take it as cash unless the giver can put a “gift only” restriction on it, meaning it can only be spent, not taken as cash. The gift certificate could be deposited with a particular company, also, forcing use with that company, as with conventional gift certificates. This could even be a local company in the recipient's town, like a restaurant. This possibility of getting gift certificate purchases would entice more businesses to register and make offerings through this system, including all the big retailers. They might compile many “gift catalogs” on various themes.

Online catalogs could offer this modular feature, or premade affiliated e-mails on themes (dresses, cat items, lures, etc.) to be downloaded from their site, registered, and forwarded. They would be getting their best prospects identified for them by their own customers.

### Embodiment 33

Making Connections Adopt a Pet:

Adopt-A-Pet: An adopt-a-pet affiliated e-mail series, which consists of catalogs of pets that need homes in an area (or a series of them prepared by the local shelters) may be provided. It may be sponsored by a pet food company, which offers a free 2# bag of pet food (or other incentives) to anyone who adopts a pet. The company stands to gain a customer, and get good will for sponsoring the shelter and its affiliated e-mails. The shelter gets to place more animals. People who love animals would love to get this affiliated e-mail.

These affiliated e-mails could tell the whole story of each animal, with pictures. With the modular approach it would be a simple matter to generate these stories/modules as animals come in, and post them to the service provider's online database. Others would compile them into affiliated e-mails sorted by category (puppies, kittens, breeds, needing fostering, good with kids, etc.) and region and send them to people who have asked to receive this information. Or each module can be a complete affiliated e-mail and the database program can match up its profile with requested profiles and automatically send it out.

Compilations may be periodic. Whenever the status on an animal is changed the e-mail that goes out is altered. Members wanting to find out about a particular animal would get the latest update to verify it is still there, and so on.

So there might be two forms in which to receive the material. One is individually (filtered by the criteria desired). The other is in compilations, also filtered by criteria.

Spouse Bounty: A person could make a personal affiliated e-mail about themselves and place a bounty on a mate. Whoever winds up connecting them with the person they marry receives the reward. Networks of matchmakers and of people looking for a mate might develop who forward these e-mails to each other, cooperating either to find their own mates or to find them for people they know. Catalogs of relatively short presentations on each person may be linked to a more complete website. These could be compiled in the same modular fashion as described above, so matchmakers could specialize in personality types, interests, characteristics, etc. Knowing the information is always current (if you have the latest version, which is always what is sent out, and which can be updated with a click) would add a great deal to the value.

Job and Personnel Search: A very similar process would work for job seekers, and for those looking to fill positions, whether job related or any other sort of personnel need (partners for kayaking expeditions, etc.).

The American Lost and Found: Each nation could have its own lost and found. When a thing, an animal, or even a person, is lost or missing, an affiliated e-mail about them is created.

In the case of children, there could be a free (sponsored) national program to make up affiliated e-mails about children ahead of time, just in case, for instant posting. It could have a phone code, so a person could call a toll-free hotline and speak the code to have the stored affiliated e-mail published within minutes after it is determined the child is missing. It would be posted in appropriate categories of topic and region (based on its profile as predetermined), with whatever reward, if applicable, and automatically forwarded, if the affiliated e-mail profile so indicates, to law enforcement agencies such as border guards.

Then it can be updated with details of the disappearance and anyone suspected or known to be involved, vehicles, etc., as soon as possible. Full information such as questions to ask the child to which they would give unique responses, detailed physical descriptions of marks and so on, along with several photographs, may lead to more recoveries of children.

Anyone who wanted to could of course subscribe to get these messages as they are posted. When the child is recovered the updated compilation is re-sent, with a message of the outcome to provide an end to the story for everyone aware of the situation.

In less urgent circumstances, this would be a way that found articles or animals (or kids) could be reunited with their owners. If the owner put out an affiliated e-mail the finder could track it down by searching for it based on characteristics of the item. In the case of a person, elements of the affiliated e-mail coding could already identify aspects of the person's identity, such as gender, age, eye color, and other major characteristics, perhaps including name, so that if a child is found but the identity is not known one could narrow the search easily to the right description.

Or the finder of a missing person or item could send an affiliated e-mail describing the found person or item so that the owner could find it. The same sort of program for pets would provide owners with an instant affiliated e-mail to post if a pet turned up missing, and allow them to pull it when the pet was found. This could be a boon to shelters, allowing them to reunite a larger percentage of lost pets and owners.

Focus groups: Focus groups for any product, service, or other offerings, including politicians, to test affiliated e-mails before they were sent out may be established. The e-mails could be non-forwardable and protected in every way possible so they stay within the focus group. Collect participants by profile (and permission). Test affiliated e-mails on them for their reactions, revise and test again with the same group or another. This could be quite inexpensive compared to face-to-face focus groups, and could involve larger numbers of people. It is specific to developing effective affiliated e-mails, but it could also prove effective in other areas as well, such as testing policy ideas for political palatability, and language.

Secure document transfer: If a secure transmission means is possible, this format may prove useful to official agencies (police departments, etc.), law firms and corporations for transmitting data such as police alerts and investigation files, personnel files, criminal case files and legal briefs, contracts and other important documents. In these cases and in many others it may be necessary to provide good security end to end. It is useful because it can transmit documents to subscribers efficiently, and handle subscribes and unsubscribes. Businesses with many field agents, such as network marketing organizations, could use this as part of their means of keeping in touch with the people in their organizations.

### Embodiment 34

Additional Opportunities For Providers

Small producers of goods and services: Depending on the fees to get started, small craftspeople and the like can make affiliated e-mails to sell their wares. There will be people looking for unique, handmade things, so those could comprise their seed list. Others could compile the products of a number of craftspeople into affiliated e-mails of unique items, acting in the role of critic/cataloger.

Others in a similar position might be companies or individuals facing the barriers of communication across national boundaries, or economic differences or limitations that make conventional media unattainable. Villages worldwide might be able to support themselves and preserve their communities by exporting local crafts. Another category is individuals and companies in any country that offer a good service but have trouble reaching larger markets, especially location-independent services like programming or writing or design.

Company-sponsored lotteries: Large companies could offer a lottery. The 10,000^{th} person to pass on their affiliated e-mail might win a new car, or a trip, or the millionth person to visit their website gets a million dollars.

Brick and mortar stores could keep in touch with their customers on a local level: Local stores could assemble affiliated e-mail modules from manufacturers they represent into their own affiliated e-mail sale fliers and/or catalogs that are sent to their local customers, again according to the profiles the customers set. Chains stores could do the same for their regions or nationally. There could be a gift or discount for passing the affiliated e-mail to 2 or 3 other qualified people (live in the area, over 18, etc.). Then they have to come into the store to collect the gift or redeem the coupon. The system notifies them when they have earned it, and gives them the code they need to collect at the store.

This would allow small businesses to reach customers in a way they never could afford to before. A small restaurant could send an e-mail stating: “Come try our new soup recipe, winner of the local soup competition, only $1.00,” which they likely could not afford otherwise. They could reach potential customers they could never find otherwise through the pass-along feature, and by reaching people who had set their profiles as open to their category in general (local food offerings, local business of their type in general, or new local businesses, or sales by local businesses, etc.).

A business or organization can post their affiliated e-mail on the hub for perusal by anyone interested in what is going on in any aspect of their town. If a user wants entertainment, the user looks under entertainment in his/her zip code then town name for the type he/she is looking for, or at specific places he/she likes, to see what's happening there, or for a band, say, to see what their affiliated e-mail says they are up to now.

Of course, one could subscribe to a compilation of all this material, perhaps by genre (food, art, music, drama, children's events, etc.) that others would create as their business or be hired to create by a group of local businesses in cooperation with each other.

This system could provide a sort of general clearinghouse of connections that anyone can tap into, without having to set up or manage their own system. All the money is handled for them, the seed lists are supplied through requested, opt-in profiles, the affiliated e-mail composition software is easy to use and is online, on demand. They can pay per use, which controls their costs and makes it easily available to everyone. There could even be a free version that contains an ad for the system.

### Embodiment 35

Publishing Alternatives

The E-mag: All of the above “Making a Connection” affiliated e-mails could be published on a regular schedule, which would make them like a magazine. Someone could receive them as a free subscription (or paid, as a product, with custom content such as a story by a well known author). Somebody puts it together, then it is distributed through the network in a very automatic fashion. It could include any combination of editorial, modular or custom product affiliated e-mails, links, and so on.

This scheme can be made completely automatic in the case of specific regularly published e-mags. Take the dating scene: Every time a user gets her e-mag collection of summaries of affiliated e-mails about this week's crop of single guys who are into outdoor sports and between 24 and 28, who live in her area, the tracking system can automatically pull up anyone in her profile list who has been set to receive this, and send notification that a new compilation with additions and deletions is available, then the same happens on down the line. Distribution becomes hands-off and instant, but commissions are still earned because the affiliations are maintained and tracked.

Means for deciding who gets to send to people on multiple send lists are provided, for example by protecting existing affiliations. That makes acquiring affiliates even more valuable. The varieties of permutations that could arise from using these building blocks is quite large.

Print magazines: These could offer a mini (or even a full) version of themselves in an affiliated e-mail with clickable ads. The magazine stands to get new subscribers to the paid, print version as existing subscribers pass it to their friends. It would get passed on because those passing it would earn money from sales of products in the ads, because they think it would be interesting to their friend, and there may be special discounts on the products offered only through the affiliated e-mail so they can feel good about doing their friend a favor.

The magazine could also make money from advertisers based on the number of exposures (which the e-mail tracking system counts) or on each click-through, or as actual commission on product sales originating from their e-mag.

This is a way to prospect for subscribers that actually pays the publishers money. It would give them a lot of feedback about what their audience likes and does not like, too, by tracking the responses and asking for electronic feedback, very valuable to magazine management.

To clarify the prospecting for subscribers aspect: A print magazine could create a mini version of itself, with real ads. People would be rewarded for passing that mini-version on to someone who subscribed (or in the two tier version, they also get rewarded if that person passes it to someone who subscribes). The magazine gets paid by the advertisers for these targeted exposures and/or for purchases made through them. This allows the magazine to afford to put these out regularly, perhaps as a new revenue source, perhaps defraying the cost of seeking print subscribers, and perhaps as a new publication that is Internet based only.

### Embodiment 36

A Print Hybrid, the Magazine/catalog

This embodiment starts with printed media. A positive opportunity for magazines seeking subscribers (this could include nonprofits seeking members and/or contributions), is that they can offer in their print outreach a web connection to this system. Here they sell some set of related products, possibly at a discount, and offer free or paid subscriptions to the lite (Internet) or real (paper) version of the publication. The Internet version is the e-mag, with the usual ad modules (no doubt closely related to their print advertisers, and possibly custom or exclusive ad modules). So their direct mail prospecting could earn them money as people buy the product(s) featured, even if they do not subscribe.

So they might sell something, and the further interaction and display of the benefits of and type of content in the magazine increases the chance of a subscription. Access to purchasing a set of items chosen by the editors becomes another benefit of being a member/subscriber, and another reason to subscribe.

Thus, they could make an offer such as this: If you subscribe or become a member, you will have access to our restricted website where products of particular relevance to our readers/members are available at a discount. As a prospect we are giving you limited access to, say, the featured item of the month, not to the entire selection, or to the entire selection for a limited period of time. (You can also pass on our E-mag version of this promotion to a friend, by the way, and earn $x or credit in our shop if they subscribe.) Note that this is using other media to funnel people into the propagation system of affiliated e-mails.

Products in the shop could be items that are reviewed or advertised, or simply displayed in illustrations. The publication includes a code in the print magazine that refers the reader to the appropriate web reference (it could be the issue and page). This turns a regular magazine into a catalog, again expanding the income potential for print publications. Every time someone visits the online store they have a chance to send an affiliated e-mail to their contacts featuring single items or collections of items.

It could work like this: A teenage girl gets a subscription offering to YM, a girl's magazine, in the mail. She checks out the offering of a great discount on clothes in their online store. She sees a piece of clothing she likes, creates an affiliated e-mail with an ad module about that piece, and sends it (through our hub) to a friend, saying, “I'm thinking of getting this. What do you think?” The affiliated e-mail contains the same YM subscription offering, and access to the store with the same discount. So with one mailed offering, now there are two girls exposed to it, and thinking about buying clothes in their online store, and exposed to all the other inducements they can offer online, including a free “lite” e-mag subscription that puts them in ongoing contact with these girls, through which they can sell more clothes and pitch the print magazine, for both subscriptions and newsstand sales. If they have something hot to offer, this could then spread rapidly through the whole “teenage girl clothes” affiliated e-mail network of connections. The mailed piece becomes a way to recruit a seed list, for another way to look at it.

### Embodiment 37

Article Bank/Everyone a Publisher

Writers could put up articles, jokes, and material of all sorts. People could compile their own e-mags complete with this editorial and ad modules, and send them free to their subscribers. This makes everyone a publisher if they want to be. Writers are paid per issue that gets forwarded, or a percentage of commissions earned by the publisher (there could be many payment schemes). The publisher (the person who compiles the collection of editorial and product ads) has to balance that cost against the income they earn from the commissions on the products included in the magazine.

Writers could set different rules about how their material is available. Some could demand cash, others could take their chances on a percentage. They could require individual approval or make it available to anyone, perhaps as long as a specific credit line is included, and the article is uncut. There are many specific arrangements that could be made, and all listed with each writer's profile.

Access to the pool of articles could be limited to those who have paid a fee and passed a credit check, and who thereby qualify to earn a second level of commission. They may get a commission for every sale produced by the affiliated e-mail no matter how many generations of propagation it has gone through. All it takes is the ability to put together a compilation of stuff that is appealing, and to get a good seed list.

### Example

A user, Johnny, could make up “Johnny's Favorite Hot Rod Stuff” and can include any editorial he finds that he thinks will add to the appeal of his affiliated e-mail, and can of course write it himself. He gets to format it all with the use of design software he got access to with his fee paid to the system to become a publisher. He publishes it when ready to his list, and collects a fee for everything sold though his affiliated e-mail, as do the people who send it on. They collect on one or two tiers, but Johnny as the creator of the vehicle earns on every sale at any level.

### Example

Independent news sources and networks could find themselves by sending their information in the form of an affiliated e-mail directly to subscribers, and collecting commissions from sales from ads they include.

### Example

Professionals could recruit celebrities, or celebrities could hire professionals, to create their own e-mags.

There may be cases where a provider does not want their ad modules included in certain types of publications, so the provider would have the option of placing restrictions on who could use them. For instance, one political party might restrict the other from inserting the first party's modules into the sender's e-mags, where they might pick them apart and analyze them for weaknesses.

### Embodiment 38

Authors

Book authors could find their readers using the present system.

### Embodiment 39

Paid Newsletters

Paid newsletters are a large business. These could easily migrate to this system, saving paper and postage costs and gaining in timeliness. Security means to prevent forwarding of these newsletters other than to paying subscribers may be provided, e.g., through a “read-only” coding.

Back issues could be made available online for purchase or as an additional benefit of being a subscriber. Affiliated e-mails with themes from back issues could be sold, as these publications sometimes compile books from past newsletter articles now and sell them.

### Embodiment 40

Online Credits and Debits

With all the exchange of money this system facilitates, it is reasonable to consider another possibility. Instead of individuals who earn commissions automatically getting a check, they could choose to have credits from earnings banked online and made available for purchases or other expenses. Holding it this way until a check is requested will cut down on costs of writing and mailing checks, and could generate interest income. The user could indicate in their profile how they want their credits handled (hold until requested, send a check whenever it reaches a certain amount, monthly if it is above the provider's minimum, etc.).

The service provider may also affiliate with online banks and allow online banking of credits into a fully functional bank account.

Some providers (affiliated e-mail originators) with proper credit could be given the option of using the hub's optional escrow and payment services. The hub provider could set its own policies about when to require this to assure payments are all made properly, and when to give the outside company this option.

### Embodiment 41

Income Generators for Participants

Private sales: Adding an affiliated e-mail module to an auction item, so it can be sent to a friend who might be looking for just that item, could be popular.

Non-auction private sales also take place. Sellers could make affiliated e-mails about houses, cars, boats, property, businesses, horses, tools, planes, condo and vacation rentals, houses and apartments for rent, and anything else. The provider could provide a payment escrow service on these items where it makes sense. The seller can pay a commission for anyone connecting them to a buyer.

### Embodiment 42

Forwarding Income:

Another use of this system is users may earn a credit in some cases simply by sending an affiliated e-mail to some number of people, whether they buy or not. The affiliated e-mail publisher's point would be to get the word out or establish name recognition. The tracking system ensures exposures are to new people who have not gotten it before. A credit is simply added to the sender's account when they achieve the goal. This would be useful for some products, or for companies trying to establish a brand, or for existing companies that change their name, and so on. It might be a way a movie trailer would be spread around.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information. While embodiments of the present invention will be described with reference to the Internet and the World Wide Web, the system and method described herein is equally applicable to other network infrastructures or other data communication systems.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A system to facilitate computer-based commerce, the system including:
an offering dispatch module to facilitate communicating a provider offering to a user if the offering is within a category designated by the user as being acceptable for receipt of such offering; and
a rewards module to reward the user if the user satisfies a reward criteria, the reward criteria including the user propagating the provider offering to a second user.

2. The system of claim 1, including:
a user profile monitor to maintain a user profile, the user profile including one or more user selections from a plurality of categories, each selection associated with an area of interest;
a vendor communication module to detect receipt of the provider offering; and
an offerings monitor in communication with the provider communication module to identify the offering as associated with an offering category and to store the offering in an offerings database.

3. The system of claim 1, wherein the communicating of the provider offering to the user being without revealing the user's contact information or the user's identity to the provider.

4. The system of claim 2, including a user communication module in communication with the user profile monitor to receive a selection from the user and to store the selection in the user profile, wherein the selection includes one or more of adding a category and removing a category.

5. The system of claim 4, including an intelligent agent to:
identify a related category associated with the selection of the at least one category:
identify a product associated with the related category; and
publish the associated product to the user.

6. The system of claim 5, wherein intelligent agent being to invite the user to select the related category to be included in the user profile, responsive to identifying the user as being interested in the associated product.

7. The system of claim 2, including a statistics generator to automatically generate a value associated with a number of user profiles identified as including the offering category.

8. The system of claim 2, wherein the user profile is independent from the user's communication service provider.

9. The system of claim 2, wherein the offering dispatch module is to:
detect a change to the user profile,
identify the change as an additional category in the user profile,
identify a new interest offering in the offerings database, the new interest offering associated with the additional category in the user profile, and
facilitate communicating the new interest offering to the user.

10. The system of claim 1, wherein the reward criteria includes one or more events resulting from the user propagating the provider offering to the second user, the one or more events selected from a group including:
receiving a completed survey from the second user;
receiving an indication of a purchase by the second user;
receiving an indication of a click through by the second user; and
receiving a testimonial from the second user.

11. The system of claim 1, wherein the reward includes one or more items selected from a group including a credit value, one or more points, and a monetary value.

12. The system of claim 1, wherein the reward being designated to the user or a third party.

13. The system of claim 1, including a spam control module in communication with the offerings monitor to receive a spam complaint, to identify a user associated with the spam complaint, and to take an action in response to the spam complaint.

14. A method to facilitate computer-based commerce, the method including:
communicating a provider offering to a user if the provider offering is within a category designated by the user as being acceptable for receipt of such offering; and
awarding a reward to the user if the user satisfies a reward criteria, the reward criteria including the user propagating the provider offering.

15. The method of claim 14, wherein the communicating of the provider offering to the user includes:
receiving from the user a selection of at least one category from a plurality of categories, the at least one category associated with an area of interest;
storing the selection of the at least one category in a user profile;
detecting receipt of the provider offering;
identifying the provider offering as associated with an offering category; and
storing the provider offering in an offerings database.

16. The method of claim 14, wherein the communicating of the provider offering to the user being without revealing the user's contact information or the user's identity to the provider.

17. The method of claim 15, including:
identifying a related category associated with the selection of the at least one category; and
identifying a product associated with the related category; and
publishing the associated product to the user.

18. The system of claim 17, including inviting the user to select the related category to be included in the user profile, responsive to identifying the user as being interested in the associated product.

19. The method of claim 15, including automatically generating a value associated with a number of user profiles identified as including a specific category.

20. The method of claim 15, including maintaining the user profile independent from the user's communication service provider.

21. The method of claim 15, wherein the communicating of the provider offering to the user includes:
detecting a change to the user profile,
identifying the change as an additional category in the user profile,
identifying a new interest offering in the offerings database, the new interest offering associated with the additional category in the user profile, and
communicating the new interest offering to the user.

22. The method of claim 15, wherein the awarding of the reward to the user includes:
identifying the provider offering as a propagated offering; and
updating the propagated offering with the offering data stored in the offerings database.

23. The method of claim 13, wherein the awarding of the reward to the user is responsive to:
receiving a completed survey from the second user;
receiving an indication of a purchase by the second user;
receiving an indication of a click through by the second user; and
receiving a testimonial from the second user.

24. The method of claim 13, wherein the awarding of the reward to the user includes awarding to the user one or more items selected from a group including a credit value, one or more points, and a monetary value.

25. The method of claim 13, wherein the awarding of the reward to the user includes awarding the reward to a third party, the third party being designated by the user.

26. The method of claim 13, including:
detecting a spam complaint from the user;
identifying a provider associated with the spam complaint; and
taking an action in response to the spam complaint.

27. A method to facilitate computer-based commerce, the method including:
means for communicating a provider offering to a user if the provider offering is within a category designated by the user as being acceptable for receipt of such offering; and
means for awarding a reward to the user if the user satisfies a reward criteria, the reward criteria including the user propagating the provider offering to a second user.
